(19) United States
(12) Patent Application Publication
(10) Pub. No.: US 2026/0362070 A1
(43) Pub. Date: Nov. 12, 2026

(54) SYSTEM COMPRISING A HEARING DEVICE WITH MAGNETIC CONNECTION

(71) Applicant: VIBROSONIC GMBH, Mannheim (DE)

(72) Inventors: Tobias BEHR, Mannheim (DE); Johanna BOLLEREY, Mannheim (DE); Daniel BRUCH, Mannheim (DE); Tobias FRITZSCHE, Mannheim (DE); Tim PUSCH, Heidelberg (DE); Jonathan SCHÄCHTELE, Mannheim (DE); Volker STEENHOFF, Mannheim (DE); Florian STROBL, Heddesheim (DE); Martin THEURING, Mannheim (DE)

(73) Assignee: VIBROSONIC GMBH, Mannheim (DE)

(21) Appl. No.: 19/122,481

(22) PCT Filed: Oct. 20, 2023
(86) PCT No.: PCT/EP2023/079361

§ 371 Date: Apr. 18, 2025

(30) Foreign Application Priority Data
Oct. 21, 2022 (DE) 10 2022 211 218.0

(51) Int. Cl. H04R 25/00; G02B 6/38; H01R 13/62; H04R 1/10; H04R 25/02

(52) U.S. Cl. CPC H04R 25/606; G02B 6/389; H01R 13/6205; H04R 1/1016; H04R 1/1033; H04R 25/02; H04R 2225/023; H04R 2225/57

(57) ABSTRACT

The invention relates to a system comprising a first device that is configured to be arranged in an ear canal and that has a first contact element, and a second device that has a second contact element. The first and second contact elements are configured to contact each other and to transmit energy and/or data when they come into contact. The first and second contact elements are configured to be held in contact with each other by magnetic force.

The invention relates to a system comprising a first device that is configured to be arranged in an ear canal and that has a first contact element, and a second device that has a second contact element. The first and second contact elements are configured to contact each other and to transmit energy and/or data when they come into contact. The first and second contact elements are configured to be held in contact with each other by magnetic force.

There are several reasons for inserting a system, for example a hearing aid, as deeply as possible into the external auditory canal (CIC: completely in the canal). The reasons for this may be aesthetic, since such a hearing aid is hardly visible from the outside, which is desired by many users. The occlusion effect caused by systems that close the ear canal is less pronounced the smaller the enclosed volume and thus the deeper the system is placed. Sound pick-up deep in the ear canal also leads to a more natural sound sensation, as the directionality of the auricle is retained. Reasons related to the operating mode may also play a role. Some systems are designed in such a way that positioning cannot be carried out by the user themselves, but only by qualified specialist personnel (e.g. an ENT doctor). In particular, the hearing aid can also be positioned completely or partially on the eardrum. The problem with this category of hearing aid is that, in certain situations, it must be possible to remove at least parts of the hearing aid from the ear canal. Furthermore, in certain situations it is necessary to transmit power and/or some form of represented acoustic signals and/or other data to the part of the system that is worn in the ear.

The Sonova Holding AG Group sells the product Lyric under the brand name Phonak, which is inserted deep into the external auditory canal and remains there permanently during the product's service life. The capacity of the non-rechargeable battery determines the service life of the product, which must therefore be completely replaced by a doctor or acoustician approximately every three months. However, it would be advantageous if the device was equipped with a rechargeable battery and could be recharged while being worn in the ear.

In order to be able to guarantee a sufficient operating time, the manufacturer had to do without otherwise common hearing aid functions in the Phonak Lyric. The device has analog signal processing and no connection options for external devices and audio sources. Also, audiological adaptation to the user's hearing loss (fitting) is only possible to a very limited extent. In addition, the user can only operate basic control functions (sleep mode, on/off, louder/quieter) with the help of a control aid (SoundLync), with which certain movements must be made in the ear.

The Earlens Device from Earlens Corporation has a component that is placed directly on the eardrum and is supplied with power and signal by a contactless optical or, in the latest product generation, inductive connection. The transmitted light source or coil is placed in a fitting in the ear canal. The microphone(s), signal processor and battery are located in a behind-the-ear housing. The system can therefore be seen from the outside unless the wearer's hair covers the housing behind the ear. Another problem with this approach is the high losses in the conversion of electrical energy into optical radiation or magnetic fields and back again. Furthermore, the optical system is highly susceptible to dirt contamination or incorrect alignment of the transmitted light source and receiver. A contactless solution was chosen in this case, as there was previously no solution for realizing a stable wired connection with a component placed deep in the ear canal that could be inserted by the user.

The object of the present invention is to provide a system comprising a component arranged in the ear canal that can be easily connected to and disconnected from a replaceable component.

The object is solved by the system according to claim 1. The dependent claims specify advantageous further embodiments of the system according to the invention.

According to the invention, a system is provided that comprises a first device adapted to be placed in an ear canal. This means that the first device is dimensioned in particular so that it fits into a person's ear canal. The dimensions can be average dimensions of the total population or average dimensions of a specific population cohort, for example a specific age group. However, the dimensions can also be those of an individual ear canal of a specific person for whom the first device and the system are dimensioned.

According to the invention, the system also has a second device which can, but does not have to, be arranged in the ear canal. The second device can also be located outside the ear canal, for example.

The system according to the invention may advantageously be a hearing system, a hearing aid, headphones, in-ear headphones, a drug delivery device and/or a wearable system for monitoring vital signs (such as body temperature, blood oxygen saturation, blood pressure, tissue glucose concentration, electrical activity of the heart or brain, position or acceleration of the body, etc.). The system according to the invention is particularly suitable as a hearing system and/or hearing aid.

According to the invention, the first device has a first contact element, and the second device has a second contact element. The first and second contact elements are configured to contact each other and transfer energy and/or data between the first and second devices when they come into contact with each other. Energy and/or data can therefore be transferred from the first to the second device and/or from the second to the first device.

The first and second contact elements are designed to be held in contact with each other by a magnetic force.

Preferably, the first contact element can have at least one first magnetic force element for this purpose, and the second contact element can have at least one second magnetic force element. These at least one first magnetic force element and at least one second magnetic force element are then configured to exert a magnetic force on each other. In this embodiment, a magnetic force element of a first contact element should therefore exert a magnetic force on a magnetic force element of the second contact element. The number of first magnetic force elements of the first contact element can be equal to the number of second magnetic force elements of the second contact element, but it is also possible that the number of first magnetic force elements is greater or less than the number of second magnetic force elements.

Magnetic force elements are to be understood here as magnets on the one hand and elements with magnetizable material on the other, in particular elements that have material on which a magnet exerts a force and which itself does not exert a force on the same material. Magnets are understood to be elements that generate a magnetic field themselves, in particular permanent magnets and electromagnets.

Advantageously, at least one magnetic force element selected from the at least one first magnetic force element and the at least one second magnetic force element has a magnet. The other magnetic force element can have or consist of a magnetizable material with the property described above. Alternatively, the at least one first magnetic force element and the at least one second magnetic force element can each have a magnet.

Magnets can be permanent magnets and/or electromagnets. For example, one of the contact elements can have at least one electromagnet as the corresponding magnetic force element and the other of the contact elements, which exerts a magnetic force with it, can have magnetizable material as the corresponding magnetic force element. This is then held in contact by the magnet by means of magnetic force.

The first device is designed to be placed in the ear canal. It is preferably held there with a certain force so that it does not move unintentionally. Preferably, the magnetic force elements are then dimensioned such that they keep the first and second contact elements in contact with one another with a force that is less than a force that is required to remove the contact element and/or the first device from the ear canal.

In an advantageous embodiment, the first device and/or the first contact element and/or the second device and/or the second contact element can have an anchoring component with which the corresponding device and/or the corresponding contact element can be anchored in the ear canal and/or on an eardrum and/or on an auricle. The anchoring component can, for example, be arranged on an outer surface of the corresponding device or the corresponding contact element and, when the corresponding device or the corresponding contact element is arranged in the ear canal, contact the ear canal wall, i.e. be arranged between the corresponding device or the corresponding contact element and the ear canal wall. In particular, an anchoring can be produced in the sense that the corresponding device or the corresponding contact element is supported on the ear canal by means of the anchoring component. In particular, the anchoring component can counteract the force with which the corresponding device or the corresponding contact element can be removed from the ear canal and/or moved within the ear canal.

In an advantageous embodiment of the invention, the first contact element can be connected to the first device in a mechanically flexible, preferably rotatable and/or tiltable manner. The first contact element can therefore be rotatable and/or tiltable relative to the first device. The connection can be made via a flexible element such as a wire, an optical fiber or a strip. Firstly, this makes it easier for the first contact element to come into contact with the second contact element during the contact-making process. In addition, such a flexible design can prevent movements of the second device from being transferred to the first device in an undesirable manner and possibly displacing it. In addition, such a flexible design can prevent a force from being exerted on the first device during the process of establishing contact between the two contact elements, which leads to a (possibly undesired) movement of the first device within the ear canal. Such a movement could be, for example, pushing the first device too deeply into the ear canal, which could cause pain or injury to the user.

In this document, the term “connection” refers to the arrangement of the first and second contact elements in contact with each other.

If magnets are used in the system according to the invention, these can preferably contain a ferrite, at least one rare earth, at least one hard magnetic material, cobalt, nickel, neodymium, samarium, or consist of one or more of these substances. If magnetizable material is used, this can be iron, steel, preferably with added silicon, iron-nickel alloy, iron-cobalt alloy, or consist of these materials. The magnets and the magnetizable material may contain one or more of these substances.

The magnetic force elements can advantageously be permanent magnets and/or electromagnets, the use of permanent magnets being advantageous. These can, for example, contain or consist of iron, cobalt, nickel, neodymium, samarium and/or other ferrites and/or rare earths and/or other hard magnetic materials or a combination of these materials. However, the magnetic force elements can also be components that consist at least partially of a ferromagnetic material with soft magnetic properties, such as iron, steels with added silicon, iron-nickel alloys, iron-cobalt alloys and other iron and steel alloys, but are not permanent magnets. In this case, the corresponding counterpart in the other contact element can be a permanent magnet or electromagnet. The connection is therefore preferably at least one of the following variants:
One contact element has at least one permanent magnet and/or electromagnet, the other contact element has at least one ferromagnetic element.
One contact element has at least one permanent magnet and/or electromagnet, the other contact element also has at least one permanent magnet and/or electromagnet, wherein the poles of the magnets are aligned for the connected case of the connection in the intended position such that an attractive effect prevails between the magnet or magnets of one contact element and the magnet or magnets of the other contact element.

The locking force of the connection can advantageously be designed such that the connection is released when a force is applied to the releasable contact element, for example by pulling or turning the contact element or another component mechanically connected to the contact element, before the contact element connected to the releasable contact element is moved out of its intended position by the applied force. In an advantageous embodiment, the locking force is therefore lower than the holding force of an anchoring component to which the connection can optionally be mechanically connected or which can contain the connection.

In addition, the locking force of the plug-in connection can advantageously be designed in such a way that the two contact elements do not become detached from each other during normal movements that the wearer of the system performs in their everyday life. Preferably, the locking force can be>=50 mN, particularly preferably>=100 mN. This has the advantage that the connection can be maintained while the system is being worn and therefore power and/or data can also be transmitted via the plug connection during operation.

In an advantageous embodiment of the invention, at least one, but optionally also several or all of the magnetic elements may be sheathed in a further material, for example in order to achieve better corrosion resistance, biological compatibility or another advantage. This sheathing material can, for example, be a precious metal such as gold, platinum, iridium or an alloy thereof or another material such as a plastic (e.g. silicone, parylene), a ceramic or a combination thereof.

In a further advantageous embodiment of the invention, the sheathing material of one or more magnetic force elements may comprise or consist of a non-magnetic material, wherein the thickness of the sheathing material in the region between the at least one magnetic force element of one contact element and the at least one magnetic force element of the other contact element allows the magnetic force acting on one another between the at least two magnetic force elements to be reduced in a targeted manner. Similar to the use of a spacer element, the advantage here can also be, for example, that a working range of the magnetic force can be set that is less strongly influenced by manufacturing tolerances. However, other advantages that can be achieved by using a spacer element can also be achieved with the help of the sheathing material.

In an advantageous embodiment, the first and/or the second contact element and/or its respective magnetic force element and/or the first device and/or the second device can have a sheathing which covers the corresponding contact element and/or the corresponding magnetic force element and/or the corresponding device completely or completely with the exception of an electrical contact. The electrical contact is preferably the contact via which energy and/or data can be transmitted between the first and second devices upon contact. The entire first device and/or the entire second device can have such a sheathing, of which the corresponding contact elements and their magnetic force elements are part.

The sheathing can also completely cover the corresponding contact element as described, so that the corresponding contact element or the corresponding magnetic force element is not exposed at any point on its surface. Energy and/or data transmission may still be possible, for example via optical, capacitive and/or inductive coupling.

The sheathing is preferably corrosion-resistant and/or biocompatible. Advantageously, the sheathing is non-magnetizable and non-magnetic. Advantageous materials for the sheathing are, for example, gold, platinum, iridium, an alloy of the aforementioned materials and/or plastic. Plastics can be silicone and/or parylene, for example. Alternatively or additionally, the sheathing can also contain or consist of ceramic. If the sheathing is made of metal, the first and second contact elements can be galvanically coupled, even if the sheathing completely covers the corresponding element.

In an advantageous embodiment of the invention, the first and/or the second contact element may comprise a sheathing or covering layer at least in a region that is in contact with the other contact element when the first and the second contact element contact each other, so that energy and/or data can be transferred between them. This sheathing or layer is preferably non-magnetizable and non-magnetic. A thickness of this sheathing or layer can then be selected such that the magnetic force keeps the first and second contact elements in contact with each other with a force that is less than a force required to remove the first contact element and/or the first device from the ear canal. The magnetic force with which the first and second contact elements are in contact with each other can therefore be adjusted by means of such a sheathing or layer. Preferably, the magnetic force is set with regard to the advantageous anchoring of the corresponding component, so that the anchoring holds the corresponding component in the ear canal with a greater force than the magnetic force between the first and second contact element.

In general, in a state in which the first and second contact element are in contact with each other, the magnetic force is preferably greater than or equal to 1 mN, preferably greater than or equal to 15 mN, preferably greater than or equal to 20 mN, preferably greater than or equal to 50 mN, preferably greater than or equal to 100 mN and/or less than or equal to 1000 mN, preferably less than or equal to 800 mN, preferably less than or equal to 600 mN, preferably less than or equal to 500 mN, preferably less than or equal to 400 mN, preferably less than or equal to 300 mN.

The corresponding magnetic force can also be adjusted by the type of magnets and/or the type of the magnetizable material. If the solenoid is an electromagnet, the magnetic force can be adjusted via the current flow in the coil of the electromagnet. In addition, said sheathing or cover layer can be used to adjust the magnetic force to the desired value range.

In an advantageous embodiment of the invention, the at least one first and/or the at least one second contact element can have at least one spacer element on a surface that faces the respective other of the contact elements when the first and second contact elements are in contact with each other. The spacer element can thus be arranged on that surface of the first and/or the second contact element that faces the surface of the other contact element when the contact elements are in contact with each other such that energy and/or data can be transmitted between the first and the second device. In this embodiment, the spacer element can determine the distance between the at least one first and the at least one second contact element at the location of the spacer element. To this end, the spacer element can protrude beyond the surface on which it is arranged, for example. Preferably, the spacer element has a height, measured perpendicular to the surface of the contact element on which it is arranged, which is smaller than a diameter of this contact element in the direction parallel to this surface. Preferably, the height of the spacer element is, for example, less than or equal to 5 mm, particularly preferably less than or equal to 4 mm, particularly preferably less than or equal to 3 mm and/or greater than or equal to 250 μm, particularly preferably greater than or equal to 500 μm.

Such spacer elements can be used, among other things, to adjust the magnetic force with which the first and second contact elements are held in contact with each other. For given magnets, the larger the spacer element, the smaller the magnetic force will be.

In addition, such spacer elements can also be used to cause a certain tilting of the first contact element relative to the second contact element when they are in contact with each other. The contact elements can advantageously be integrated into the corresponding first or second device. In this case, the spacer elements can also cause the devices to tilt in relation to each other.

Preferably, two or more such spacer elements can be provided between the contact elements. For example, two spacer elements define a straight line parallel to the contact surfaces of the contact elements, around which the contact elements or the devices can be tilted. Such a tilting movement can then be designed in particular in such a way that the contact elements on the magnetic force elements can be moved away from each other by means of a lever around the spacer elements. If a tensile force is then applied to the second contact element, this can generate a torque around the spacer elements that moves the magnetic force elements away from each other. At the same time, it can still be ensured that the contact elements are held firmly together and in contact with each other in the absence of such a tensile force.

Advantageously, the two or more spacer elements can be arranged on one of the facing surfaces of one of the contact elements or distributed over both contact surfaces.

In an advantageous embodiment of the system according to the invention, at least one of the magnetic force elements can be arranged on or in at least one of the surfaces on which the spacer elements are arranged. Particularly preferably, the at least one magnetic force element can be arranged on one side or both sides of a row of spacer elements that is preferably straight, next to the row of spacer elements, viewed in the direction parallel to the surface. Preferably, the spacer elements protrude beyond the magnetic force elements in a direction perpendicular to the corresponding surface. Such a design is particularly advantageous in order to bring about the tilting described above and the leverage effect around the spacer elements.

In an advantageous embodiment of the invention, at least one mechanical spacer element (preferably at least two spacer elements) can be provided, which is attached to at least one of the contact elements and is positioned between the opposing (contact) surfaces of the contact elements when the magnetic force-locking connection is established as intended. In this way, a defined distance between the contact elements can be created at the location of the at least one spacer element, whereby the magnetic force acting between the at least one magnetic force element of one contact element and the at least one magnetic force element of the other contact element can be reduced in a targeted manner compared to direct contact between the corresponding magnetic elements.

Preferably, the at least one spacer element therefore protrudes from the corresponding contact element and also protrudes beyond the at least one magnetic element. Among other things, this is advantageous in order to compensate for any manufacturing or other tolerances of the magnetic force elements or other components with regard to size or other component parameters, as this method allows the magnetic force range of the force between the at least two magnetic force elements when connected to be varied in a targeted manner. This allows a more favorable ratio of the change in magnetic force to the change in the distance between the at least two magnetic force elements to be set, which can also reduce the influence of manufacturing tolerances on the maximum magnetic force upon contact between the connector components. In this context, more favorable means that the change in the magnetic force is less pronounced due to the change in the magnetic force elements in relation to each other. In a particularly advantageous embodiment, the distance between the complementary magnetic force elements of the two contact elements when connected as intended is <=5 mm, preferably <=4 mm, particularly preferably <=3 mm and >=100 μm, preferably >=250 μm, particularly preferably >=500 μm.

The length with which the at least one spacer element can protrude from the plug component is preferably smaller than the diameter of the contact element measured orthogonally to the direction in which the at least one spacer element protrudes from the contact element. Particularly preferably, said diameter in this direction is smaller than the diameter of the ear canal of the person in whose ear the connection is to be located. Preferably, the at least one spacer element protrudes less than 2 mm, particularly preferably less than 1 mm, from the contact element.

In a preferred embodiment of the invention, several spacer elements can be arranged in a row on one or both of the contact elements. In this embodiment, the at least one magnetic force element of the contact element can preferably be arranged next to the at least one spacer element, but can also be arranged below it.

In a preferred embodiment, in which at least two spacer elements are arranged in a row on one or both of the contact elements, the at least one magnetic force element can preferably be arranged to the side of this row. In a particularly preferred embodiment of the invention, at least two magnetic elements can be arranged on the contact element, with at least one magnetic force element being arranged on each side of the row created by the arrangement of the spacer elements. The corresponding complementary contact element can also have magnetic force elements arranged in such a way that a magnetic force-locking connection is created when a connection is made.

If a connection is made, this can lead to a tilting mechanism between the two contact elements. This allows the contact elements to be tilted towards each other in a defined manner without preventing the mechanical connection. For the preferred embodiment of the invention, in which at least two magnetic force elements are arranged on both sides of the row created by the arrangement of the spacer elements, the contact elements can be tilted either in one direction or in the other direction pointing towards the respective magnetic force element.

An advantage of this embodiment of the invention is that forces caused, for example, by movements of a person carrying the connection or acting on these persons from the outside can be balanced by the tilting mechanism and thus these forces do not lead to a loosening of the connection. A further advantage of this embodiment of the invention is that a connection can be made at different angles between the two contact elements. This is particularly advantageous if the contact elements are to be arranged in a part of a person's ear canal where this ear canal is not straight but angled. For manufacturing reasons, it can also be advantageous to allow different angles between the contact elements in the event of a connection being made, as the ear canals are individually angled differently. Compared to a embodiment in which one or more of the contact elements have a fixed angled shape, this also has the following advantage: If the connection is designed with, for example, two oppositely polarized magnetic force elements and with a fixed beveled angle of the contact surface to its longitudinal axis, this automatically results in a defined handedness of the connection, i.e. inserting the connection into a left or right ear canal would result in a fixed and different orientation of the magnetic and electrical poles of such a connection in relation to the head. However, this restriction does not apply to the tilting design of a connection.

In an advantageous embodiment, at least one of the contact elements can have a bend that extends in the direction of the other of the contact elements upon contact. The corresponding contact element can therefore have two sections that are at an angle of 180° to each other. Preferably, this can be an obtuse angle. This design allows the contact element to follow the course of the ear canal at the location where it is positioned. In addition, a lever mechanism can also be realized in this way, which promotes separation of the contact elements against the magnetic force when a tensile force is exerted in a suitable direction. If the corresponding contact element is integrated into the corresponding first or second device, i.e. arranged within a housing of the corresponding device, this housing can also have the bent shape described.

In an advantageous embodiment of the invention, both the first and the second contact element can each have at least one magnet. The magnets of the contact elements can then be arranged in such a way that they attract each other when the contact elements are in a position relative to each other in which energy and/or data can be transmitted between the first and the second device. In addition, the magnets can preferably be arranged in such a way that they repel each other when the contact elements are in a position relative to each other in which no energy and/or data transmission can be established as intended. If the contact elements have contacts via which the data and/or energy is transmitted, a north pole of one contact element can be located at a south pole of the other contact element. In positions in which the contact elements are not in contact with each other but are sufficiently close for a magnetic force effect, the force effect of the magnets on each other can pull the contact elements into a position so that the contacts are in intended contact. In this context, contacts should not only be understood as galvanic contacts, but also as transmission paths for inductive, capacitive and/or optical transmission.

Possible principles for the transmission of power and/or data can be divided into two categories by way of example: wired (galvanic) transmission and wireless transmission. Possible embodiments of wireless energy transmission include, but are not limited to, capacitive, inductive or electromagnetic (including optical) energy transmission or a combination thereof.

With wired transmission, the transmission can be galvanic. For this purpose, in one possible embodiment of the invention, the contact elements can have at least two compatible plug contacts, spring contacts, spring-loaded pin contacts, exposed electrode contacts, etc., or a combination thereof, which generates an electrical contact between the contact elements when the connection is made and thus enables power and/or data transmission between the two contact elements.

The contacts can comprise an electrically conductive material. In one possible embodiment of the invention, the contacts may be coated with or consist of a corrosion-resistant metal (such as gold, platinum, iridium or alloys thereof).

In another possible embodiment, the electrical contact can be established via one or more magnetic force elements or their sheathing.

The shapes of the surfaces producing the electrical contact can advantageously be round (spherical segment), oval (ellipsoidal segment), pointed (e.g. conical or pyramid-shaped), flat, crown-like or otherwise shaped. In an advantageous embodiment of the invention, the electrical contacts or contact surfaces can be spring-loaded on one or both sides and/or mechanically flexibly connected to the corresponding contact element.

In another advantageous embodiment of the invention, the electrical contacts can be rigidly connected to the contact element.

In a possible design of inductive energy transfer between the contact elements, both contact elements can each have at least one coil, whereby an alternating magnetic field can be generated in one contact element with the aid of a suitable electrical circuit and the one or more coil(s), which induces an alternating voltage in the coil(s) in the other contact element. Power and/or audio signals and/or other data can be transmitted from one contact element to the other. Simultaneous or time-delayed transmission of power and/or data in a different direction is also possible.

In an advantageous embodiment of the invention, the alternating voltage in the contact element receiving the alternating field or in a further component connected thereto can be rectified with the aid of a suitable electrical circuit and used to charge a rechargeable battery.

In an advantageous embodiment of the invention, one or more of the magnetic force elements can be positioned relative to the coils in such a way that it positively influences the transmission of power and/or data by improving the coupling between the coils by means of suitable field guidance or by increasing the inductance by reducing the magnetic resistance.

In an advantageous embodiment of a capacitive energy transfer between the contact elements, both components can each have at least one electrically conductive surface, which surfaces are positioned as conformably and as closely as possible to each other, but electrically isolated from each other, in order to form a capacitor with the highest possible capacitance. An alternating voltage can be generated in the one contact element with the aid of a suitable electrical circuit and applied to the capacitor there. In one possible embodiment of the invention, the voltage generated in the capacitor part of the other contact element due to the resulting electric field can be rectified with the aid of a suitable electrical circuit and used to charge a rechargeable battery after possible electrical (low-pass) filtering.

In an advantageous embodiment of an optical transmission of power or energy between the contact elements, one or more light sources (for example LED, laser diode, etc.) with an emission spectrum in the range of 350 nm-2000 nm (preferably in the range of 550 nm-1600 nm) can be used in the one connector component, in particular: a range of 1400 nm-1600 nm in such a way that, with or without the help of one or more suitable optical elements (optical lens, etc.), the optical radiation can be directed as completely as possible onto an optical receiving element in the other connector component (Photodiode, solar cell, etc.) and thus a charge separation and thus a voltage can be generated there by, for example, the internal photoelectric effect, which can be used, for example, to charge a rechargeable battery. Alternatively, one or more light sources can be accommodated in a further component to which the magnetic connector can be mechanically and optically connected in such a way that the light generated by the further component can be transmitted to the magnetic connector, for example via one or more optical waveguides (e.g. glass fiber(s)). The optical emission power can be constant over time or can vary over time. Parallel transmission of data is also possible by suitable modulation of the light source or by a second transmission channel with a different wavelength or spatial separation. It is also conceivable to transmit data only, wherein the optical energy does not have to be used to charge a rechargeable battery.

In an advantageous embodiment, both contact elements can each have one or more permanent magnets that are aligned in such a way that they only attract each other in one position or only in a limited number of positions. As a result, when they approach each other, the magnetic forces cause them to align themselves so that they end up in one of the positions in which there is an attraction. If at least one of the two contact elements has at least one electromagnet, the polarity can be reversed by reversing the current to switch between positions or to actively release the connection.

According to the invention, the first and second contact elements can generally represent a galvanic, a capacitive, an inductive, an electromagnetic and/or an optical connection for the transmission of energy and/or data.

Advantageously, the first and second contact elements can have mutually compatible contacts, i.e. contacts that transmit energy and/or data on contact. The first and/or second contact element can particularly advantageously be a plug contact, spring contact, spring-loaded pin contact and/or an exposed electrode contact. Such contact elements can then be used to create a galvanic coupling.

It is particularly advantageous if one of the two surfaces of the first and second contact elements that can be brought into contact with each other is concave and/or the other surface is convex. In this way, the bringing together of the contact elements is facilitated and the correct position is ensured. One or both of the surfaces that can be brought into contact with each other can advantageously be spherical segment-shaped, ellipsoidal segment-shaped, conical, pyramid-shaped or crown-shaped.

In an advantageous embodiment of the system according to the invention, the energy and/or the data can be transmitted optically. For this purpose, the first or second contact element can have a light source, for example a light-emitting diode or a laser diode. The other of the contact elements can then have an optical receiving element, for example a photodiode or a solar cell. The light source and the receiving element are then arranged on the contact elements in such a way that when the contact elements are correctly positioned in contact with each other, the light source emits light onto the optical receiving element. To find this position, the previously described embodiments are also advantageous, in which the magnetic force effect moves the elements making the contact into the correct position relative to each other.

Advantageously, the light source can have an emission spectrum in the range of greater than or equal to 350 nm, preferably greater than or equal to 550 nm, particularly preferably greater than or equal to 1400 nm and/or less than or equal to 2000 nm, preferably less than or equal to 1600 nm. The optical receiving element then preferably has a receiving spectrum into which the emission spectrum of the light source falls, preferably completely.

In an advantageous embodiment, the energy and/or the data can be transmitted optically. For this purpose, the second device can advantageously have at least one optical waveguide with which light can be conducted to the second contact element. The first contact element can then have an optical receiving element, preferably at least one photodiode or at least one solar cell. In turn, the optical receiving element can preferably be set up to convert light energy in the range of greater than or equal to 350 nm, preferably greater than or equal to 550 nm, particularly preferably greater than or equal to 1400 nm and/or less than or equal to 2000 nm, preferably less than or equal to 1600 nm, into voltage.

In an advantageous embodiment of the invention, the first contact element can be arranged at the end of a cable, the other end of which is connected to another element of the first device. Additionally or alternatively, the second contact element may be arranged at the end of a cable, the other end of which is connected to another element of the second device. This design allows the contact element to move flexibly in relation to the other element of the corresponding device. This allows the contact element to move, due to the magnetic force, by itself into the position specified by the effect of the magnetic force, in which contact is then established for the transmission of energy and/or data. Advantageously, the further element of the first device may be an eardrum component arranged on and in contact with an eardrum of the person using the system. The eardrum component can then be configured to transmit vibrations directly to the eardrum. In this case, it is particularly advantageous if the first contact element is connected to this eardrum component via at least one cable or an optical fiber. In this way, the first contact element can be brought into contact with the second contact element without displacing the eardrum component.

In an advantageous embodiment, the further element of the first device can have two sub-elements that are connected to one another, for example by a cable. One of the partial elements facing the eardrum can be the eardrum component and the other partial component can be an intermediate element that is connected to the contact element, e.g. via a cable, and which is connected to the eardrum module, e.g. via a cable. The intermediate element can advantageously be accommodated in the ear canal with an anchoring component.

In one possible embodiment of the invention, the connection or first contact element may be connected to an eardrum component or be part of an eardrum component that may be at least partially disposed on a person's eardrum. The connection can be directly mechanically fixed or also mechanically at least partially decoupled, but electrically conductively connected to, the eardrum component via a cable. The cable can contain one or more wires and/or at least one strip conductor, which are preferably insulated from each other and from the environment by an insulating material, preferably plastic. In a preferred embodiment of the invention, the cable may be a flexible printed circuit board on a polyimide substrate with strip conductors comprising or consisting predominantly of gold.

It is particularly advantageous for the cable to be flexible or twisted in a spiral. In a further advantageous embodiment, the cable may have a flexibility with respect to twisting such that a torsion occurs at a certain number of rotations with respect to an initial position, leading to a tensile stress in the direction of an axis between the eardrum component and the magnetic coupling, which on the one hand is large enough to lead to an effective shortening of the wire along said axis when inserting the magnetic coupling into the ear canal, but on the other hand is low enough not to cause the eardrum component to slip or pull away from the eardrum, and wherein the torque acting on the eardrum component is low enough to avoid twisting of the eardrum component or injury to the eardrum. Preferably, a torsion that is sufficient for an effective shortening of the cable to a length corresponding to the intended distance between the eardrum component and the magnetic coupling occurs at a number of rotations <=10, preferably <=5, more preferably <=2. Preferably, the flexibility of the wire/cable/cable component is such that a number of turns >=0.5, preferably >=1, more preferably >=2, more preferably >=5, more preferably >=10, does not lead to a tensile force or torque on the eardrum component that leads to slippage or detachment of the eardrum component from the eardrum or that leads directly or indirectly to injury to the eardrum.

Advantageously, the at least one cable can have one or more wires. If several wires are present, one or more wires can be combined to form wires of the same potential. Wires of different potentials can be separated from each other by insulating material. One or more wires of the same potential can be surrounded by insulating material.

Alternatively or additionally, the at least one cable can also have at least one strip conductor, which is arranged on a printed circuit board, the printed circuit board preferably being flexible. A printed circuit board should preferably be understood here as an object extending over a flat surface, which particularly preferably has a longitudinal direction in which it extends further than in the transverse direction perpendicular to it. Preferably, it extends at least twice as far, particularly preferably at least five times as far, in the longitudinal direction as in the transverse direction. The strip conductor can be applied to the surface spanned by the longitudinal direction and the transverse direction. Preferably, the at least one wire and/or the at least one strip conductor is insulated from the environment by means of at least one insulating material.

Advantageously, the at least one cable can be formed as a layer comprising gold or consisting of gold on a polyimide substrate.

In an advantageous embodiment, the at least one cable can be flexible and/or spiral-shaped in such a way that a distance between the first contact element and the element arranged at the other end of the cable, for example the drum head element, can be varied elastically.

In an advantageous embodiment of the system according to the invention, the at least one cable of the first device can be resilient against twisting, so that it causes a tensile force between the first contact element and the further element of the first device arranged at the other end of the cable when twisted by a minimum number of turns. Preferably, this force is such that it holds the first contact element in the ear canal and/or such that it prevents the element of the first device arranged at the other end of the cable from slipping and/or twisting.

Preferably, this condition is fulfilled for at least 0.5 revolutions, particularly preferably at least 1 revolution, more preferably at least 2 revolutions, more preferably at least 5 revolutions, more preferably at least 10 revolutions.

Preferably, the cable is designed in such a way that a twisting of less than 2, preferably less than 5, more preferably less than 10 turns, does not lead to a slipping or twisting of the further element of the first device arranged at the other end of the cable.

One of the advantages of the embodiments described here is that, for example, an eardrum component can be placed on the eardrum without another component, such as the magnetic coupling, which is formed by the first and second contact elements, or a component connected to the magnetic coupling, being worn in the ear canal, which could impede or prevent the process of placing the eardrum component on the eardrum. The eardrum component can have an actuator which, when subjected to a corresponding electrical signal, generates an acoustic oscillation in such a way that it produces an auditory impression in the person on whom the eardrum component is placed on the eardrum. In this case, the connection of the contact elements can be used to transmit the electrical signal to the eardrum component from another external component placed, for example, in the ear canal, in or on the person's ear. The outer component can be directly mechanically connected to the contact element or at least partially mechanically decoupled, but electrically and/or optically connected to the contact element, for example with one or more cables and/or optical fibers.

In an advantageous embodiment of the invention, the second device can have an ear canal element which can be arranged in the ear canal and which has the second contact element. Preferably, the second device can also have an outer element which can be arranged further outside than the ear canal element in the ear canal or outside the ear canal, the second contact element preferably being arranged on the ear canal element, e.g. being fixedly arranged.

The second contact element can be directly mechanically connected to the ear canal component or also mechanically at least partially decoupled, but electrically connected to the ear canal component, for example with one or more cables or optical fibers. In this case, the connecting element can be used to transmit power and/or data from the external component to the ear canal component. The outer component can be permanently connected to the contact element or at least partially mechanically decoupled, but electrically and/or optically connected to the magnetic connector, for example by at least one cable and/or optical fiber. The outer element and the ear canal element can therefore be connected via at least one cable and/or at least one optical fiber, via which energy and/or data can be transmitted to and/or from the second contact element, with the optical fiber and/or the cable preferably being flexible.

Advantageously, the ear canal element can have a rechargeable battery. This can then be charged electrically and/or optically by the external component via the contact element, for example. The second contact element can also be used to transmit audio signals, control signals, configuration data, status data and/or other data from the external component to the ear canal component or in the opposite direction from the ear canal component to the external component.

The mechanical decoupling of the second contact element can be designed so that a flexible cable extends from the ear canal component to the outside or from the outer component to the inside, at the end of which the second contact element is attached. Both components can also have a flexible cable facing the other component. The cable(s) are advantageously designed in such a way that they are as long as, or longer, in total than the distance to be bridged in the intended end position, i.e. than the distance between the outer component and the ear canal component. An excess length of the cable compared to this distance can advantageously be in the range between 100 μm and 5 mm. More advantageously, the cable can also be flexible enough to compensate for expected misalignments (rotational and/or lateral) and can be laid in such a way that the excess length is stowed in the space between the ear canal and outer component by bending and/or folding. In an advantageous embodiment of the cable, the cable can, for example, be designed as a flexible polyimide-based circuit board with a thickness of preferably ≤100 μm.

Advantageously, the at least one cable and/or the at least one optical fiber may comprise a tube and/or a sheathing material, which is preferably chemically resistant, electrically insulating and/or mechanically flexible. Advantageously, the tube can comprise or consist of a thermoplastic, polyamide, silicone and/or an epoxy. The tube and/or the sheathing material can encase at least one wire or at least one optical waveguide.

The cable can advantageously be formed entirely or partially by an electrical conductor for transmitting electrical signals and/or power and/or by at least one optical fiber for transmitting optical signals and/or power and/or contain such an electrical conductor and/or optical fiber. Such a conductor or wire can contain or consist of many different electrically conductive materials such as, in particular, aluminum, copper, silver, gold, iridium or an alloy. Several wires can also be combined into one strand, for example to change the flexibility of the conductor and the connecting cable. An optical waveguide, which can be part of the cable or can form part of it, can, for example, comprise a material that only absorbs light of the wavelengths to be transmitted to a small extent. Typical materials here can be quartz glass or a plastic, for example.

The described tube can preferably be chemically resistant, electrically insulating and/or mechanically flexible. It can be made of polyamide as described, but can also be made of silicone or another material. At least one lumen of the tube can be air-filled or filled with another material. At least one wire and/or at least one optical fiber can be arranged in the at least one lumen of the tube.

The cable can have a sheathing material that encases at least one wire and/or at least one optical fiber. The at least one wire and/or the at least one optical fiber can, for example, be cast into the sheathing material. The sheathing material can, for example, be a silicone, a thermoplastic such as polyamide and/or an epoxy or consist of these. Other materials or combinations of different materials are also possible here.

The cable can advantageously have at least one stabilizing component. This can, for example, be arranged analogously to a wire or an optical fiber within or partially within the tube or the sheathing material, without fulfilling a function of transmitting electrical energy and/or optical signals and/or power. The at least one stabilizing component can, for example, be made of a textile, plastic, metal, but also other materials or a combination of different materials.

In an advantageous embodiment of the invention, the cable can have a round cross-section over its entire length. In a preferred embodiment, however, the cable can also have regions that have a cross-section that differs from a round cross-section. In these regions, the cable can preferably be oval or flat in shape. Its diameter along the narrower axis can be less than 75%, preferably less than 50%, particularly preferably less than 35% of the diameter along the wider axis of the cable. A particular advantage here is that the person inserting a contact element into an ear can do this by holding the connecting cable. The non-circular cross-section in some regions of the connecting cable makes it possible for this person to recognize an unguided orientation of the contact element and thus bring it more easily into its intended position.

In an advantageous embodiment of the invention, the at least one cable or the at least one optical fiber can have at least two regions along its length with different numbers of surrounding tubes, different numbers of lumens inside the tube, different wall thicknesses and/or different materials. For example, an increase in the number of surrounding tubes will lead to a stiffening of the cable in this region.

The stiffness of the cable can be influenced in various ways in terms of design and/or production. For example, the number, diameter and/or material of at least one electrical conductor and/or at least one optical fiber can be adjusted in order to achieve the desired stiffness. The stiffness over the course of the cable can therefore also be varied by varying these parameters over the course of the cable.

In a preferred embodiment, the stiffness of a section of the cable that engages an element that can be arranged facing the eardrum can be greater than a stiffness of a section that engages an element that can be arranged facing away from the eardrum. This increases the guideability of the cable, for example.

Also advantageously, a stiffness of a section that engages an element that can be arranged facing an eardrum can be less than a stiffness in the rest of the cable or optical fiber, this section extending over less than 10 mm, particularly preferably less than 5 mm, particularly preferably less than 1 mm away from this element. Such a section helps to prevent the eardrum-facing element from exerting unwanted forces, e.g. on the eardrum or the ear canal.

The stiffness of the cable or optical fiber leads to a certain stability of the shape of the cable or optical fiber, so that the at least one cable is held on the ear during an intended connection of the first contact element to the second contact element in such a way that it does not or only slightly touches the skin and/or facilitates the holding of an outer module, cable and/or first and/or second contact element. Advantageously, the stiffness of the at least one cable can be designed in such a way that it maintains a predetermined shape. It can also be designed in such a way that the shape of the cable can be corrected by a user.

Advantageously, the cable can have a varying stiffness over its length. For example, in the case where the outer component or second device is worn outside the ear canal and the cable for connecting the ear canal element or the second contact element to the first contact element inserted into the ear canal, it may be advantageous that the stiffness of the at least one cable in a part that is worn in the ear canal is higher than the stiffness of the part of the cable that is worn outside the ear canal. However, other distributions of the stiffness of at least one cable over its length are also conceivable.

In a further advantageous embodiment, the stiffness of the cable can be lower in the region adjacent to the contact element and/or in one or more regions between the contact element and the outer module or between the ear canal element and the outer module than in the remaining part of the cable. In this way, for example, it can be ensured that the magnetic force between the first and second contact elements makes it easier to bring the two components together. The reduced stiffness of the cable in at least one region can facilitate making a connection, for example by designing the stiffness in relation to the magnetic forces in such a way that a magnetic force exerted by the contact element on the other contact element leads to a twisting and/or tilting of the contact element by at least 10°. As a result, when the contact element is inserted into the ear canal to establish a connection with the other contact element, an initially inaccurate positioning can be at least partially or completely compensated for by the first and second contact elements being automatically pulled towards an intended position relative to each other due to the magnetic forces.

A reduced stiffness of the connecting cable in at least one region can also advantageously influence the stability of the connection. Forces caused, for example, by movements of a person wearing the system or forces acting on this person from the outside can be compensated for by increased flexibility in regions of lower stiffness.

On the other hand, increased stiffness in the regions other than the regions with reduced stiffness means that a shape of the at least one connecting cable defined during manufacture or impressed by a user is maintained during handling of the system. A predefined shape of the at least one connecting cable can simplify the establishment of the connection between the first and the second contact element for the user if the shape of the at least one cable defined during manufacture or impressed by a user corresponds approximately to a course of the at least one cable in its intended position, i.e. in a connection established between the magnetic connector and the magnetic coupling. A modified stiffness can also fulfill the function of relieving strain for the at least one wire and/or the at least one optical fiber.

In an advantageous embodiment of the invention, the at least one cable or the at least one optical fiber can have a variable stiffness over its length. For example, in the case where the optional outer element is worn outside the ear canal and the cable or optical fiber for connecting the first contact element to the second contact element is inserted into the ear canal, it can be advantageous if the stiffness of the cable or optical fiber in the part that is worn in the ear canal is higher than the stiffness of the part of the cable or optical fiber that is worn outside the ear canal.

In a further advantageous embodiment, the stiffness of the cable and/or optical fiber may be lower in a region adjacent to the first contact element or second contact element and/or in one or more regions between the first contact element and the first device and/or between the second device and the second contact element than in the remaining part of the cable or optical fiber. In this way, for example, it can be ensured that the magnetic force between the first and second contact elements facilitates the joining of the two components, wherein the reduced stiffness facilitates establishing a connection.

Advantageously, a stiffness of the cable or optical fiber, particularly preferably in a bending region adjacent to that element that can be arranged facing the eardrum, on the one hand, and the magnetic force, on the other hand, are designed in such a way that the magnetic force can cause this element facing the eardrum to tilt and/or twist by an angle greater than or equal to 10° relative to a region of the cable or optical fiber adjoining the bending region. This means that when the contact element is inserted into the ear canal to establish a connection with another contact element, an initially inaccurate positioning can be partially compensated for by the magnetic forces automatically pulling the first and second contact elements towards each other into the intended position. Reduced stiffness of the cable or optical fiber in at least one region can also have a beneficial effect on the stability of the connection between the first and second contact elements. Forces that are caused, for example, by the movement of a person wearing the plug connection or that act on these persons from the outside can be compensated for by the increased flexibility in regions of low stiffness. On the other hand, increased stiffness in the other regions can lead to a shape of the at least one connecting cable defined during manufacture or imprinted by a user being maintained during handling of the system. A predefined shape of the at least one connecting cable can simplify the establishment of the connection between the magnetic connector and the magnetic coupling for the user if the shape of the cable or optical fiber defined during manufacture or impressed by a user corresponds approximately to a course of the cable or optical fiber in its intended position, i.e. in a connection established between the first and second contact element. A modified stiffness can also fulfill the function of strain relief for the cable and/or the optical fiber.

Advantageously, the cable and/or the optical fiber can have at least two regions of different diameters and/or different materials. In this way, the different stiffnesses of the cable or optical fiber described above can be realized.

If at least one tube is part of the cable or optical fiber, the stiffness of the cable or optical fiber can be changed locally, for example by changing the number of tubes, number of lumens, diameter, wall thickness, material and/or other properties of the tube at this point. If the cable has a sheathing material at least in some regions, the stiffness can also be varied by changing the thickness or material of the sheathing material.

Advantageously, the stiffness of the cable and/or the optical fiber can also be changed by the fact that the connecting cable is constructed differently in regions where the stiffness is to be different than in the other regions. For example, at least one wire, at least one optical fiber, at least one tube, at least one stabilizing component and/or at least one sheathing material may be present in regions of increased stiffness, while the corresponding component is not present in the other regions in which the stiffness is not increased.

One example of a possible embodiment has a cable and/or an optical fiber that, on the one hand, has a tube that guides a wire or an optical fiber component in its at least one lumen. Reduced stiffness can be advantageous, for example, in a region that is adjacent to the corresponding contact element or begins a maximum of 10 mm, preferably a maximum of 5 mm, more preferably a maximum of 1 mm from the distal end of the contact element and extends distally from this beginning a maximum of 10 mm, preferably a maximum of 5 mm, more preferably a maximum of 3 mm, more preferably a maximum of 1 mm. The reduced stiffness can be realized, for example, by the fact that the at least one wire or the optical fiber component in this region is not surrounded by the tube, but by a sheathing material which has a lower stiffness than the tube. In order to prevent the wire or the optical fiber component from tearing off, particularly in the region of reduced stiffness adjacent to the magnetic connector, a stabilizing component can be integrated, preferably cast, into the sheathing material at this point.

In an advantageous embodiment, the first contact element and the second contact element can each have a guide element, wherein the guide elements are designed such that they guide the two contact elements into a position in which they are in contact for energy and/or data transmission. Advantageously, the guide element of one of the contact elements can be convex and the guide element of the other contact element can have a concave shape corresponding to the guide element of one of the contact elements. In this case, the surfaces of the guide elements run parallel to and in contact with each other.

Further possible embodiments of the guide elements can be such that one of the guide elements has one or more wedge-, oval-, round-, square-, pin- or other-shaped indentations, whereas the other contact element has one or more wedge-, oval-, round-, square-, pin- or other-shaped protrusions that correspond to the negative shape or part of the negative shape of the indentation or indentations of the other guide element.

The contact elements can advantageously have a surface which, when positioned as intended, is shaped in such a way that the shape fulfills the function of a guide mechanism. This can be realized, for example, by making the surfaces of the first and second contact elements that are in contact with each other curved, the positive curvature of the surface of one contact element corresponding to the negative curvature of the surface of the other contact element.

In an advantageous embodiment, one of the two contact elements can have an edge that at least partially surrounds the contact element, for example with a height of ≤3 mm, preferably ≤2 mm, particularly preferably ≤1 mm. The edge can fulfill the function of a guide mechanism as described above.

When the two contact elements are positioned in relation to each other as intended, such a guide mechanism can prevent the contact elements from slipping, moving, rotating and/or detaching from each other when the contact elements are connected. Such a guide mechanism can also make it easier for a person making the connection to connect the contact elements. This can be achieved in particular by the guide mechanism facilitating correct orientation of the contact elements in relation to each other during connection.

In an advantageous embodiment, one of the contact elements can have a flat contact surface and the other of the contact elements can have one or more contact pins, which are arranged in such a way that they are displaceable on the contact surface when the contact elements come into contact with each other. Advantageously, the contact surface can be perpendicular to the cable or optical fiber that engages the corresponding contact element. Energy and/or data can be transmitted via such contact pins and contact surfaces.

Advantageously, one contact element can rotate into an intended position with the aid of a guide mechanism as described above when establishing contact with the other contact element. In an advantageous embodiment, which has a wired connection between the contact elements and the corresponding devices, one or more contact pins can be provided, for example, which can be spring-loaded and/or rigidly connected to the corresponding contact element. These can then be guided laterally via a contact surface on the other contact element. Such a movement can be used, for example, to remove any dirt on the contact surface by guiding the contact pins over the contact surfaces (in a kind of parallel scratching movement).

In an advantageous embodiment, one of the contact elements can have a radial protrusion. In addition, the other of the contact elements may have a radial undercut that progressively moves away from the one contact element along a circumference of this contact element, i.e. from the one that has the radial protrusion. The radial protrusion and the radial undercut can be dimensioned so that the radial protrusion can be held in the radial undercut. A smallest radius of a surface delimiting the radial undercut in the direction away from the other contact element can therefore be smaller than a largest radius of the radial protrusion, so that the radial protrusion is held between the other contact element and the said surface delimiting the radial undercut.

In this embodiment, when the contact elements are rotated in relation to each other, the protrusion can slide into the space between the other contact element and the surface delimiting the radial undercut, similar to a bayonet fitting. For example, a wedge-shaped part of one of the contact elements can engage (proximally) behind an undercut part of the other of the contact elements (for example in a recess provided for this purpose in the contact element), wherein the undercut part (in contrast to a bayonet catch) can be designed in such a way that when a tensile force is applied that moves the two contact elements away from each other, it is possible, and preferably even facilitated, for one contact element to be unscrewed from the other contact element. Such a facilitation of unscrewing can be realized, for example, by an incline of the undercut of the corresponding contact element with the undercut in the direction of rotation, which leads to a lower wall thickness at the open end of the undercut than at the end of the undercut remote from the open end. Once the connection has been successfully established by magnetic force between the contact elements, the tensile force required for the separation can be increased beyond the magnetic force in a defined manner, but can be overcome more easily by targeted simultaneous pulling and turning in a predetermined direction than would be the case with random wiggling or pure pulling movements.

In an advantageous embodiment, the first contact element and the second contact element can each have an aperture that, when the system is worn in the ear canal as intended, forms a passage from the outside to the eardrum. The apertures can preferably be cylindrical, funnel-shaped or angular. The diameter of the aperture is preferably greater than or equal to 50 μm. Such an aperture is preferably designed in such a way that it impedes the passage of acoustic sound as little as possible, particularly preferably with an attenuation of less than 10 dB. An optional anchoring component can advantageously be designed in such a way that it does not hinder the transportation of air from the distal end of one contact element to the proximal end of the other contact element when the magnetic coupling is positioned as intended.

In an advantageous embodiment of the invention, the first and/or the second device can have at least one microphone which can be connected to the respective other device for signal transmission via the first contact element and the second contact element. This can be particularly advantageous if the second contact element is connected via at least one connecting cable to an external component that can pick up and/or process electrical signals generated by acoustic excitation of the microphone by the microphone.

In an advantageous embodiment of the invention, the second contact element can be connected to the external component via at least one connecting cable, via which electrical and/or optical signals, which are generated due to an acoustic excitation of the microphone, can be transmitted to the external component. For this purpose, the external component can advantageously have a signal-processing unit with which the electrical and/or optical signals can be processed and/or amplified and, particularly advantageously, can be transmitted back to the second contact element via at least one further cable. The data processed in this way can then be forwarded to the first contact element and to the second contact element by means of one of the transmission methods described above and can then be converted in the first device, for example by means of a transducer unit, such as an actuator in an eardrum component, a balanced armature driver, an electrodynamic loudspeaker or a comparable unit, into a sound signal which can be perceived by a user, for example.

Possible types of signal processing can be, for example, one or more selected from the following: frequency-dependent adaptation of a signal to an individual hearing loss of a user, dynamic compression of a signal in one or more frequency bands, generation of anti-noise for active suppression of ambient noise.

In a further advantageous embodiment of the invention, the microphone can be part of one of the contact elements or can be electrically connected to it. A signal can then be transmitted to an external component using one of the transmission methods described above via the corresponding contact element and, if necessary, a connecting cable or optical fiber.

In an advantageous embodiment, the first contact element can be connected to another element of the first device via a cable or an optical fiber. The cable or the optical fiber can be arranged on the first contact element at a distance greater than zero from a straight line that is perpendicular to a contact surface of the first contact element with the second contact element and that intersects this contact surface at its center. The cable or optical fiber is therefore offset from this center point on the first contact element. Preferably, the cable can enter the first contact element in a direction perpendicular to the contact surface of the first contact element. The cable can preferably enter the first contact element on the side opposite the contact surface.

This design makes it possible to create a leverage effect when the magnetic connection is released by pulling on the cable or optical fiber, which makes it easier to release the connection.

In a further advantageous embodiment, the at least one magnetic element or a geometric center of gravity of several magnetic elements of the first or second contact element can be arranged close to the center of an imaginary connecting line between the connection position of this contact element with the cable or the optical fiber projected onto the proximal surface of one of the contact elements and a contact point of this contact element with the other contact element at a maximum distance from this position when the contact is established as intended. Here, a contact point of one contact element can designate a point of this contact element that, when the connection is established as intended, lies on a proximal surface of this contact element and has mechanical contact with the other contact element. Here, the position of the magnetic element or the center of gravity of several magnetic elements can be close to the center point described above if its distance from this center point is ≤10%, preferably ≤5%, particularly preferably ≤3% of the length of the imaginary connecting line described above.

Advantageously, at least one magnetic force element can be arranged in or on the contact surface of the corresponding contact element with respect to the straight line through the center point opposite the cable or the optical fiber.

In a further advantageous embodiment, the first and second contact elements can each have a contact surface via which the contact elements bear against each other upon contact. The contact surfaces can advantageously lie parallel to one another upon contact and, at least in some regions, enclose an angle of less than 80°, preferably less than 70°, preferably less than 60°, preferably less than 45°, preferably less than 30°, with a straight line that runs parallel to the wall of the ear canal at the location of the first device, if this is arranged in the ear canal as intended. Alternatively, this straight line can also be defined by extending the cables or optical fibers in regions where they enter the corresponding contact element. This allows a shearing or tilting movement of one contact element relative to the other contact element when the cable or optical fiber, preferably the one with which the second contact element is contacted, is pulled, thereby reducing the force required to release the connection. In the case of a tilting movement, it can also be achieved that the tensile force required to release the magnetic connection is not transmitted in the direction of the ear canal aperture to the anchoring component connected to or contained in the magnetic coupling, but that instead this tensile force causes a torque so that the anchoring component is pressed more strongly against the ear canal wall. In a particularly preferred embodiment of the invention, this can lead to an increase in the holding force and the anchoring component/the first or second contact element can thereby be prevented from slipping out of an intended position, so that separation of the magnetic connection can take place more easily while the first contact element remains in the ear canal as intended. This allows a higher magnetic force to be selected to hold the first and second contact elements together, so that vibrations are less likely to cause the magnetic connection to loosen.

Advantageously, one of the first and second contact elements can have one or more contact surfaces and the other of the first and second contact elements can have the same number of contact pins. Advantageously, the contact pins are then in contact with one of the contact surfaces and establish an electrical connection in each case. There is therefore preferably one contact pin on each of the contact surfaces and exactly one of the contact pins on each contact surface. At least two of the contact pins and contact surfaces are particularly preferred.

Each contact surface therefore has a corresponding counterpart in the form of a contact pin. When contact is established between the contact elements, the contact pins then come into contact with the associated contact surfaces in such a way that, in the case of electrically conductive surfaces, an electrical connection is established between one contact pin and one contact surface in each case. Advantageously, the contact pins and/or the contact surfaces can be arranged in a row, preferably a straight row, on the plug component.

Advantageously, in this embodiment, the at least one magnetic element of the first and/or the second contact element is arranged next to the at least one contact pin and/or the at least one contact surface. In the preferred case, in which at least two contact pins and/or contact surfaces are provided in a row, the at least one magnetic element can preferably be arranged to the side of this row. It is therefore not arranged in a continuation or in this row.

In a particularly preferred embodiment of the invention, at least two magnetic elements can be arranged on the first and/or the second contact element. One magnetic element can be arranged on each side of the row created by the arrangement of the contact pins or contact surfaces. The corresponding other contact element can then also have magnetic elements arranged in such a way that a magnetic force-locking connection is created when a plug connection is made.

One of the first and second contact elements can therefore have several of the contact surfaces arranged in a row, and the other of the first and second contact elements can advantageously have the same number of contact pins arranged in a straight row. The first and second contact elements can then each have at least one magnetic force element, which is arranged to the side of the row of contact surfaces or to the side of the row of contact pins.

Preferably, the magnetic polarity of the at least one magnetic element on one side of the row created by the arrangement of the contact pins can be opposite to the polarity of the at least one magnetic element on the other side of the row. In this way, the contact elements can also be brought into their intended position for establishing contact without being visible. This can be particularly useful if there are at least two contact pins and/or contact surfaces per plug component, thereby creating a proper connection between the contact elements with the correct polarity.

The magnetic force elements in the first and second contact element can therefore be magnets that are arranged in such a way that opposite poles are in contact with each other when the contact pins are in contact with the corresponding respective contact surfaces as intended.

In an advantageous embodiment, the contact pins can be spring-loaded. However, they can also be rigidly connected to the corresponding contact element. In a further possible embodiment, at least one spring-loaded contact pin as well as at least one contact pin rigidly connected to the contact element can be present.

In an advantageous embodiment, at least one contact pin can be designed as a spacer element. It is particularly preferable for several contact pins to be arranged in a row and designed as spacer elements. This allows the contact elements to be tilted in relation to each other without interrupting a possible electrical connection established by the contact elements. Advantageously, in all the embodiments described, the spacer elements can be designed as contact pins, which establish the contact for transmitting the energy and/or data.

Preferably, the magnetic polarity of the at least one magnetic element on one side of the row created by the corresponding arrangement of spacer elements can be opposite to the polarity of the at least one magnetic element on the other side of the row. In this way, the contact can be established in its intended position by the contact elements even without visual contact. This is particularly useful if there are at least two spacer elements per contact element and these are designed as electrical contact elements. As a result, the contact elements are oriented by the attracting or repelling magnetic elements when the connection is established so that a correct connection with the correct polarity is established between the contact elements.

A further possible advantage of this embodiment of the invention may lie in the fact that movements of the contact elements relative to one another, which are made possible by the tilting mechanism and which are caused, for example, by movements of a person carrying the plug connection, can remove any dirt on the contact surface(s) or contact pins by a kind of scratching movement. A further possible advantage of the tilting mechanism may be that when the connection is released by pulling on at least one cable or optical fiber attached to the contact elements, a leverage effect is created by supporting one contact element on a housing of the other contact element, which makes it easier to release the connection.

In one possible embodiment, both contact elements can each have a magnetic element that is arranged centrally on a surface that, when the contact is made, is arranged on the corresponding contact element on a side facing the other contact element. If a connection is established, the two contact elements can be rotated in relation to each other without separating the force-locking connection established by the two magnetic elements.

In an advantageous embodiment, the first and second contact elements can each have a magnetic force element, so that a magnetic force acts between the magnetic force elements of the contact elements when they are in contact. Advantageously, the magnets can each be arranged in the center of a contact surface of the respective contact element. When contact is made, the first and second contact elements are in contact with each other via these contact surfaces.

Advantageously, one of the first and second contact elements can have at least one ring-shaped contact surface in its contact surface, wherein this ring-shaped surface extends around the center point of the corresponding magnetic force element. The other of the first and second contact elements can then have at least one contact pin on its contact surface, which is arranged in such a way that it contacts the ring-shaped contact surface when the first and second contact elements come into contact.

One of the contact elements can therefore have at least one electrical contact surface in the form of a circular ring which, when the contact is made, is arranged on a side facing the other contact element and extends rotationally symmetrically to an axis that is oriented orthogonally to this surface and that runs through the geometric center of the circular ring. It is particularly advantageous if the number of contact pins arranged on the other contact element is equal to or greater than the number of contact surfaces. Preferably, these contact pins are positioned in such a way that they establish an electrical connection to the corresponding contact surfaces when the contact elements are contacted and, if the contact elements rotate in relation to each other, this electrical connection is not released due to the circular and rotationally symmetrical nature of the contact surfaces. Preferably, one of the contact elements has at least one contact pin, and the other has at least one ring-shaped contact surface.

The surfaces of the first and second contact elements that face each other upon contact are referred to as contact surfaces.

In an advantageous embodiment of the invention, the first and/or the second contact element can have at least two contact pins and can also have at least one protective structure that is arranged in such a way that both contact elements cannot be touched simultaneously with one hand. Preferably, the protective structure can have or be a non-conductive structure in which the at least two contact pins are embedded, so that their surfaces lie behind a surface of the protective structure in the direction away from the corresponding contact element.

In this way, it is possible to prevent injury to a person or damage to an electrical component electrically connected to the at least one contact surface by touching the at least one contact surface when an electrical voltage is applied to at least one exposed electrical contact surface. Advantageously, the at least one contact surface can also be surrounded by the protective structure. Due to its geometry, this can prevent contact with the contact surface. The guide mechanism may serve as a protective structure or be identical to it.

In the event that one of the contact elements is designed such that at least two contact pins protrude from this contact element, a protective structure can be arranged between every two contact pins and protrude further out of the plug component than the contact pins, so that simultaneous contact with several contact pins is prevented by this protective structure. In order to prevent the protective structure from preventing the plug components from making contact with each other, a recess can be arranged on the complementary contact element that does not have the protective structure, into which the protective structure engages when the two contact elements make contact with each other.

In an advantageous embodiment of the invention, the first device or the first contact element as well as the second device or the second contact element can each have at least one magnet as a magnetic force element, the north and south poles of which each lie next to one another in a direction parallel to a respective contact surface with which the corresponding contact element faces the corresponding other contact element. This design makes it possible for the contact elements to be moved automatically into an intended position relative to each other by the action of the magnetic forces when contact is made, in which contact is made for the transmission of energy and/or data.

In an advantageous embodiment, the first or second contact element can have at least one first magnetic force ring, preferably as the corresponding first magnetic force element, and at least one first contact arranged at a center point of the first magnetic force ring.

Advantageously, the other of the first and second contact elements, which does not have the first magnetic force ring, can also have at least one second magnetic force ring, preferably as the second magnetic force element, and at least one second contact arranged at a center point of the second magnetic force ring. Alternatively, this other contact element may comprise other magnetic and/or magnetizable elements such as one or more cubes, one or more rods or the like.

In this embodiment, one of the first and second contacts can be a contact pin. The contact pin can protrude beyond an annular surface of the magnetic force ring, in the center of which it is arranged, which faces away from the contact element in which it is arranged. As the ring-shaped element has a non-vanishing extent in the direction perpendicular to the plane in which the ring extends, it has two opening surfaces opposite each other in the axial direction. These are the aforementioned annular surfaces. They can also be referred to as end faces. The annular surface mentioned here is one of the surfaces that limits the magnetic force ring in its axial direction. If the magnetic force ring is cylindrical, for example, these would be the opening surfaces of the cylinder.

In this embodiment, the other of the first and second contact can be a contact surface that is preferably coplanar with an annular surface of the corresponding magnetic force ring that faces away from the corresponding contact element in which the contact surface is arranged, provided that this contact element has a magnetic force ring. The annular surface is to be understood here as described above. If, for example, the first contact is meant here, it can be coplanar with an annular surface of the first magnetic force ring that faces away from the first contact element, i.e. that faces the second contact element in the contacted state. The same applies in the reverse case, i.e. the second contact is meant here.

The first and/or second magnetic force ring can advantageously be magnetic and/or magnetizable. In particular, they can advantageously be permanent magnets and/or electromagnets and/or they can contain or consist of at least one magnetizable material.

Advantageously, the second contact element can also have a cable with two conductors, which is preferably arranged at a radial distance from the center point of the second magnetic force ring on a side of the second contact element that faces away from the second contact. One of the conductors can be electrically connected to the second contact and the other of the conductors can be electrically connected to the second magnetic force ring or another contact of the second contact element. In an advantageous embodiment, the cable can be a conductor strip with two strip conductors as the conductors.

In an advantageous embodiment, the contact pin can be spring-loaded, whereby preferably a spring force, with which the contact pin is spring-loaded, can be set so that the contact pin is pressed completely into the annular surface of the magnetic force ring, in the center of which it is arranged, by the magnetic attraction of the first and second contact element.

The contact elements in this embodiment can advantageously have one or more of the following properties.

The cable can advantageously be a flexible conductor strip with two strip conductors. A strip conductor can be connected to the conductive magnetic force ring, e.g. by low-temperature soldering, cold welding, ultrasonic welding and/or conductive bonding. A particular challenge here is that the Curie temperature of the magnetic material should not be exceeded.

The second strip conductor can be connected to the conductive rigid contact pin. The contact pin and the magnetic force ring can be embedded in the housing and electrically insulated from each other. Advantageously, the contact pin can be arranged coaxially to the magnetic force ring (i.e. in the center) In the other contact element, the magnetic force ring and the contact surface can be coaxially aligned and embedded in the housing. Both can serve as electrical counter-contacts. It is particularly advantageous if the magnetic force ring and the contact surface on the contact side are coplanar (this facilitates cleaning).

It is also advantageous if there is no gap between the ring and the contact surface on the contact side. In this case, the housing fills the gap in a coplanar manner. This also makes cleaning easier and avoids the accumulation of dirt, which could act as an electrolyte and cause leakage currents.

The magnetic force rings can advantageously be axially polarized and arranged so that there is a north pole and a south pole on the contact side.

Advantageously, the contact pin or the contact surface protrudes beyond the end face of the magnetic force ring on at least one side. As a result, the contact pin and contact surface are the first to come into contact when connecting. The plug can then tilt to the side until the magnetic force rings are in contact. By tilting (edge of one magnetic force ring lies on the edge/surface of the other magnetic force ring), dirt is displaced better than with flat contact.

It is particularly advantageous if the flexible conductor strip is radially offset to the contact pin/contact surface. When pulled, this causes the connector side to tilt sideways (first the contact pin detaches from the contact surface, second magnetic force ring detatches from magnetic force ring), which reduces the release force, which can thereby be less than the contact force (force that presses the contacts together when connected).

Particular advantages of this design are its (approximate) rotational symmetry, wherein the contact element sides can be rotated about the longitudinal axis as required and still find each other.

Other variants can be as follows:

The magnetic force rings can have different diameters. This allows the force and the contact position of the magnetic force rings (edge/edge or edge/face) to be adjusted.

The magnetic force rings do not need to be used directly as a contact. Alternatively, the magnetic force rings may not be used directly as contacts, but separate structures made of conductive material can be fitted in front of the magnets or magnetic force rings.

A spring-loaded contact pin can also be used instead of a rigid contact pin. If this is designed in such a way that it is completely compressed by the attractive force of the magnets, the end faces of the magnetic force rings are in direct contact with each other. The contact force is therefore more defined (attraction force of the magnetic force rings in the contact minus compression force of the contact pin).

The end faces of the magnetic force rings (or the separate conductive structures) can advantageously be provided with sharp-edged or pointed structures in order to improve their ability to penetrate dirt.

Instead of a conductor tape, a flexible cable with strands can also be advantageously used.

“Magnetic force rings with different diameters” are also magnetic force rings with different dimensions (i.e. inner, outer diameter & height) and magnetic material or magnetic quality. This allows the force, contact position of the magnetic force rings and installation space/size of the contact element to be adjusted.

In an advantageous embodiment, one of the first and second contact elements can have two cuboid, preferably cube-shaped, magnetic force elements as first magnetic force elements, which are embedded in a housing of the corresponding contact element in such a way that they protrude beyond a surface of the corresponding contact element facing the other contact element (in the contacted state) and are tilted about at least one axis relative to this surface. The statement that surfaces are tilted or tilted relative to one another is understood here to mean that the surfaces are rotated relative to one another about at least one axis, preferably two axes, by an angle of not equal to 0° and not equal to 90° or integer multiples thereof, i.e. in particular are not parallel to one another and preferably are not perpendicular to one another.

If, for example, the first contact element has magnetic force elements tilted in this way, these are embedded in a housing of the first contact element in such a way that they protrude beyond a surface of the first contact element that faces the second contact element (in the connected state) and are tilted accordingly with respect to this surface. If the second contact element has such tilted magnetic force elements, the example applies analogously.

Advantageously, the first magnetic force elements can be tilted about two axes relative to the surface of the corresponding contact element that faces the other contact element.

In this advantageous embodiment, the other of the first and second contact elements can also have two cuboid, preferably cube-shaped, second magnetic force elements that are embedded in a housing of the corresponding contact element in such a way that at least one of their surfaces faces the one contact element (i.e. that in which these magnetic force elements are not embedded) and forms part of the surface of the corresponding contact element. In the aforementioned example, in which the first contact element has the tilted magnetic force elements, the second contact element would thus have the second magnetic force elements, which are embedded in the housing of the second contact element in such a way that at least one of their surfaces faces the first contact element (in the connected state) and forms part of the surface of the second contact element.

Advantageously, the surfaces of the second magnetic force elements, which form parts of the surface of the corresponding contact element, can lie parallel and/or coplanar to this surface.

Some optional features of this design are described below.

Here too, the cable can advantageously be a flexible conductor strip with two strip conductors. A strip conductor can be connected to one of the conductive cube magnetic force elements, e.g. by means of low-temperature soldering, cold welding, ultrasonic welding and/or conductive bonding. Here, too, the particular challenge is that the Curie temperature of the magnetic material should not be exceeded.

Advantageously, a second strip conductor can be connected to the second conductive cube magnetic force element. The cube magnets can be embedded in the housing and electrically insulated from each other. The cubes can be tilted in two axes here.

The other of the contact elements can have parallel aligned conductive cube magnetic force elements that are embedded in the housing of this contact element. Both can serve as electrical counter-contacts at the same time.

It is particularly advantageous if the magnetic surfaces on the contact side are coplanar, which makes cleaning easier.

It is also advantageous if there is no gap between the magnetic force elements on the contact side. The housing can therefore fill the gap in a coplanar manner. This also makes cleaning easier and avoids the accumulation of dirt, which could act as an electrolyte and cause leakage currents.

Advantageously, the magnetic force elements on each connector side can be polarized (approximately) perpendicular to the contact surface, with the two magnetic force elements on one connector side facing in opposite directions. This means that the plug can only be connected in one polarity. This always results in two point contacts via corners of the magnets when connecting (or line contacts via edges with variation below). Dirt is better displaced by point or line contact with a sharp corner or edge than by surface contact.

It is particularly advantageous if the flexible conductor strip is attached eccentrically to the contact element. When pulled, this causes the side of the contact element to tilt sideways and first one and then the other pair of magnets are released, which reduces the release force and enables it to be less than the contact force (force that presses the contacts together when connected). A particular advantage of this design is that point or line contacts improve the displacement of dirt.

Further optional variants of this design are described below.

The magnetic force elements do not have to be cubes, but can also be cuboids or have other shapes (e.g. no right angles).

Optionally, the magnetic force elements can only be tilted in one axis (i.e. one of the possible tilt angles alpha or beta is alpha=0 or beta=0). Instead of a point contact, there is then a line contact.

Optionally, the magnetic force elements are not tilted symmetrically. The magnetic force elements can also be tilted on both sides of the plug.

The magnetic force elements do not need to be used directly as a contact. Alternatively, the magnetic force elements do not need to serve directly as contacts, but separate structures made of conductive material can be fitted in front of the magnetic force elements.

Instead of a conductor tape, a flexible cable with strands can also be used.

The embodiments described above with magnetic force rings and cuboid or cube-shaped magnetic force elements can also be combined with each other in such a way that one of the contact elements is designed with a magnetic force ring as the magnetic force element and the other contact element is designed with at least one cuboid or cube-shaped magnetic force element as the magnetic force element.

Additional (cube) magnets could be used (but not electrically contacted and possibly smaller) to improve the directness of the self-guiding->e.g. “magnet matrix” consisting of several small cube magnets similar to the polymagnet approach (see https://www.polymagnet.com/media/Polymagnet-White-Paper-3-Smart-Magnets-for-Precision-Alignment.pdf, pages 5-6).

An advantage of the connection according to the invention can be that the connection can also be made when the person making the connection does not have a direct view of the contact elements or parts thereof when making the connection. For example, a system user can create a plug-in connection in their ear themselves.

A further advantage of the invention may be that the connection can be released again by applying a sufficiently large force without, for example, having to release a further locking mechanism (positive or other non-positive connection).

In the following, the present invention is explained in greater detail by way of example with reference to a few figures. The features shown in the examples can also be realized independently of the specific example and can be combined among the examples.

The system according to the invention is described by way of example as a hearing system. This can be a hearing aid, for example. The system according to the invention may, however, also be headphones, in-ear headphones, a drug delivery device and/or a wearable system for monitoring vital signs (such as body temperature, blood oxygen saturation, blood pressure, tissue glucose concentration, electrical activity of the heart or brain, position or acceleration of the body, etc.).

### SHOWN ARE

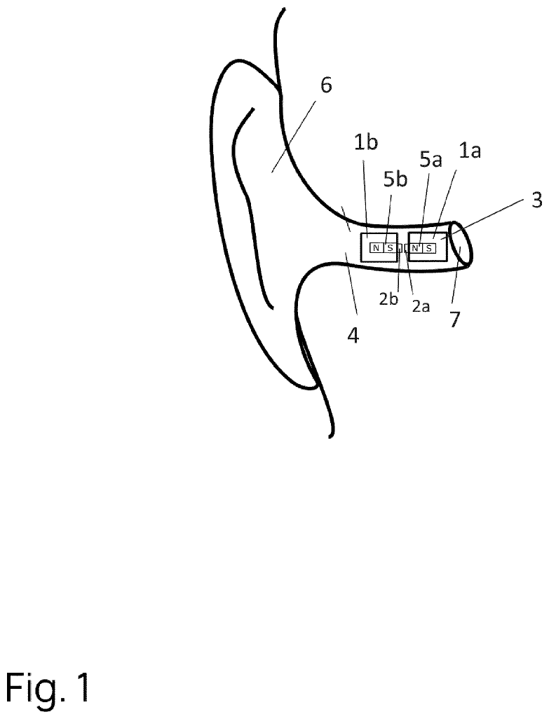

FIG. 1 an example of a hearing system according to the invention,

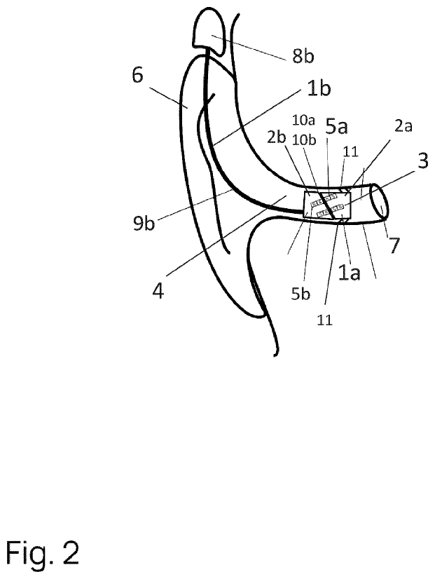

FIG. 2 another example of a hearing system according to the invention,

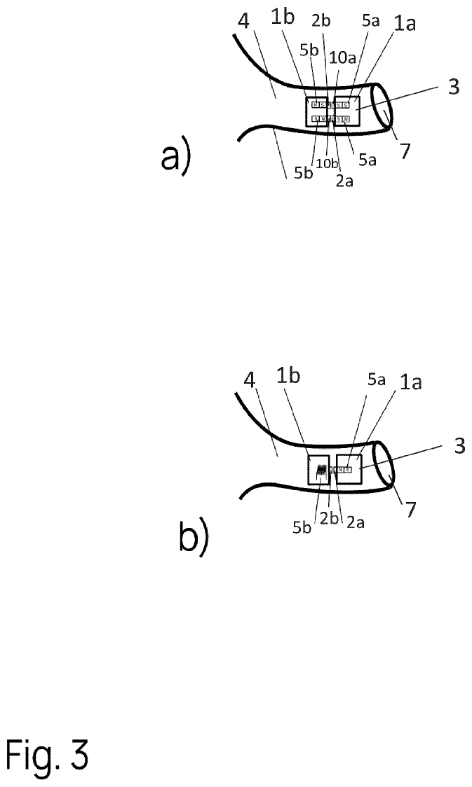

FIGS. 3a), 3b) alternative arrangements of magnetic force elements,

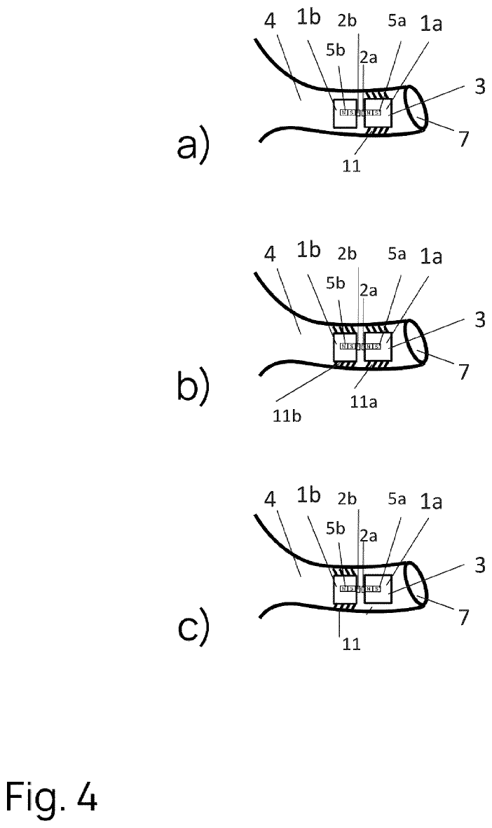

FIGS. 4a), b), c) various embodiments of hearing systems according to the invention,

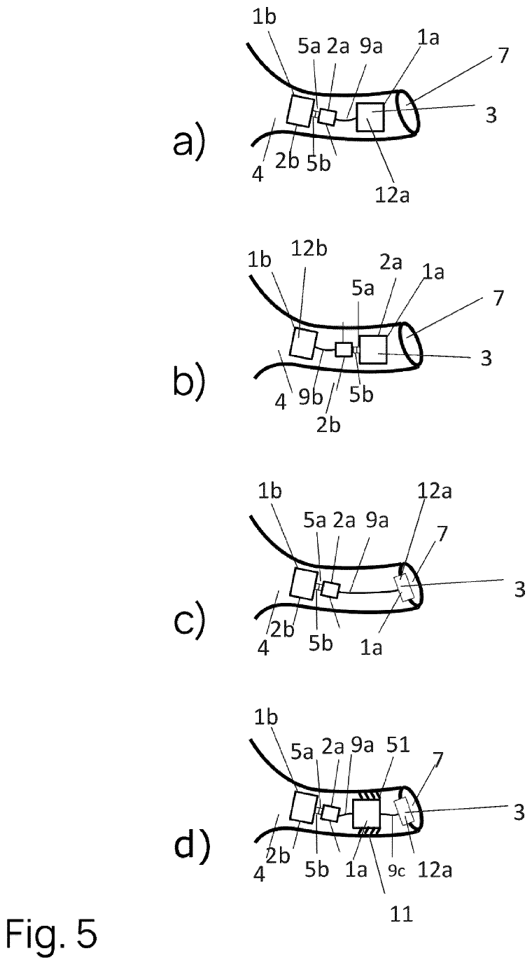

FIGS. 5a) to 5d) embodiments of the hearing system according to the invention,

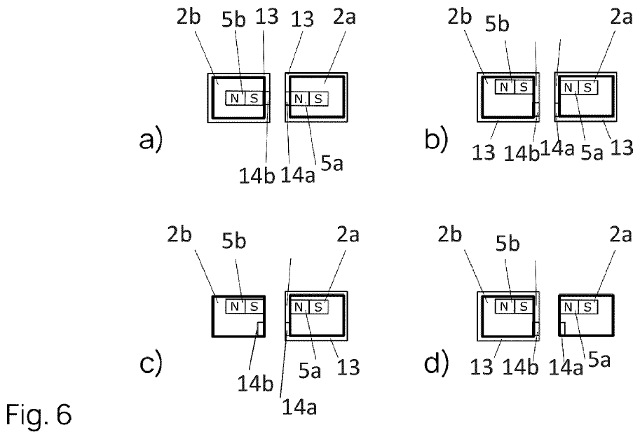

FIGS. 6a) to 6d) various embodiments of the first and second contact elements,

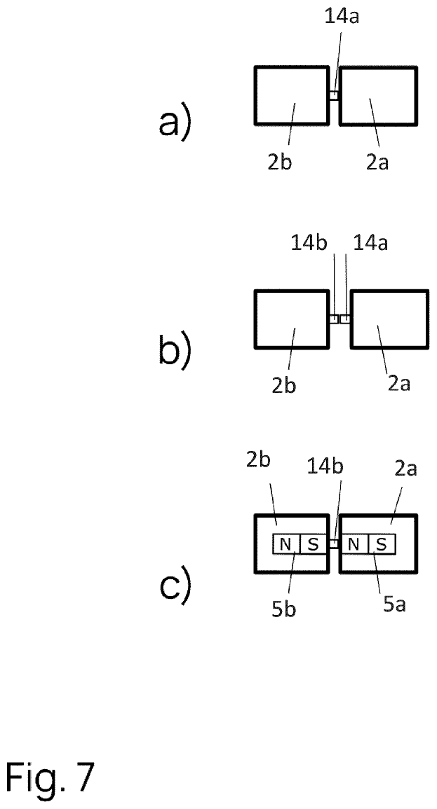

FIGS. 7a) to 7c) embodiments of the invention,

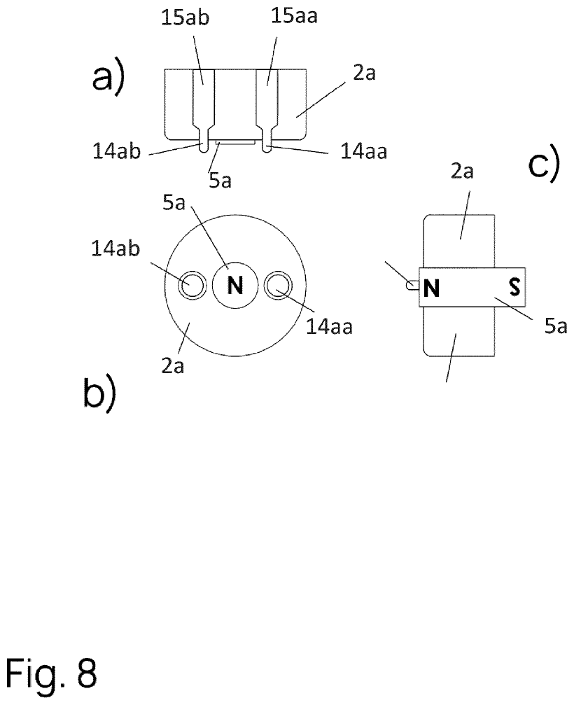

FIGS. 8a) to 8c) various views of an exemplary embodiment of one of the contact elements,

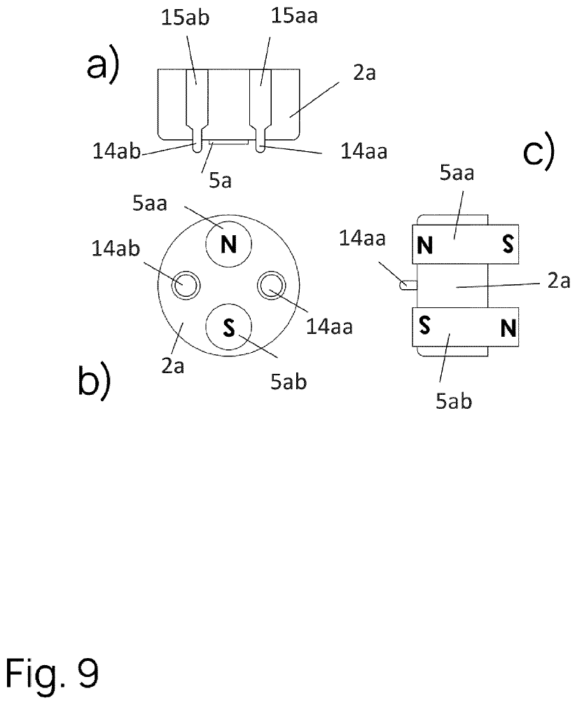

FIGS. 9a) to 9c) a further exemplary embodiment of a contact element,

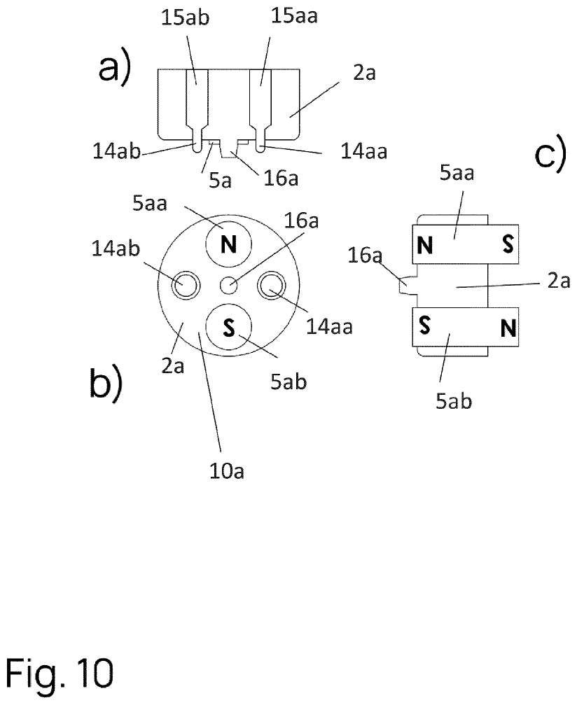

FIGS. 10a) to 10c) an exemplary embodiment of the first contact element,

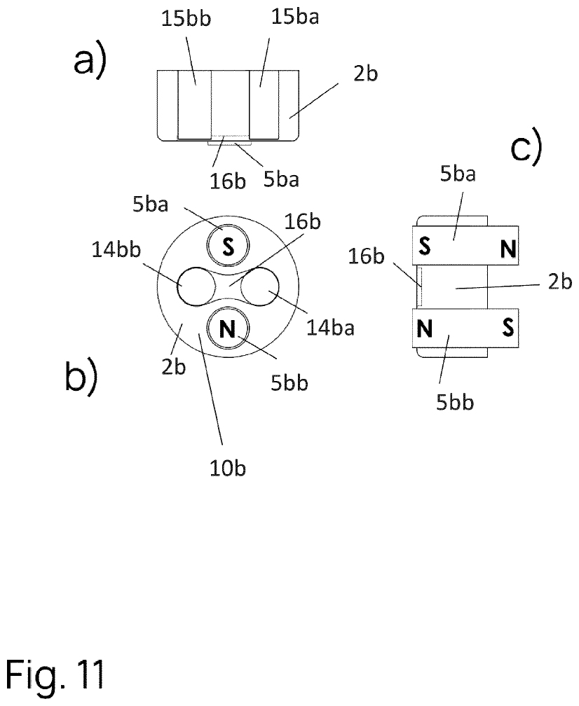

FIGS. 11a) to 11c) an exemplary embodiment of a contact element,

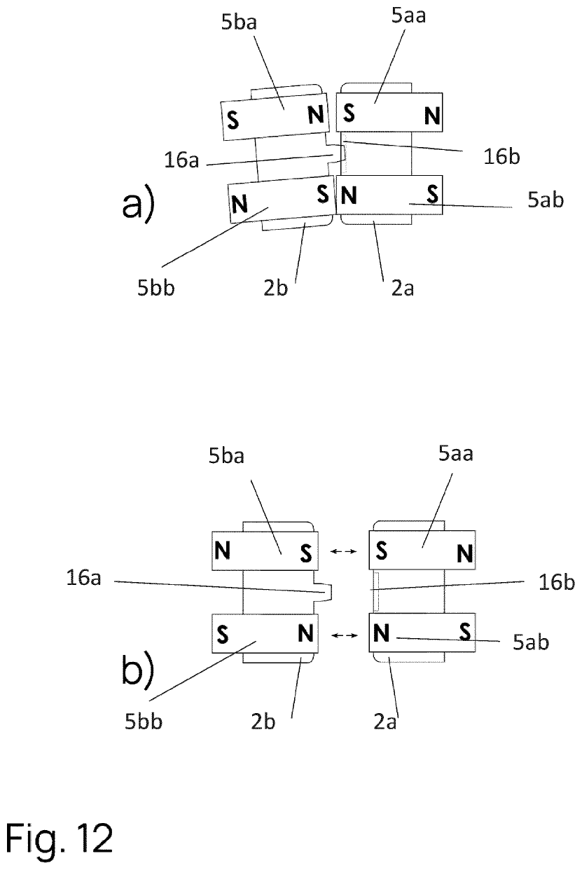

FIGS. 12a), 12b) an embodiment of the invention,

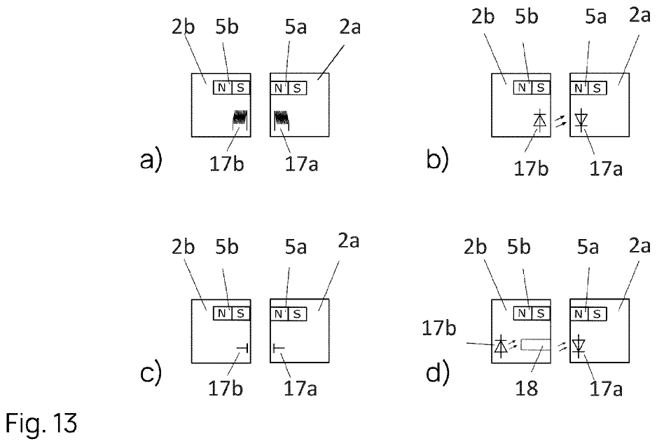

FIGS. 13a) to 13d) various options for transferring energy and/or data between the contact elements,

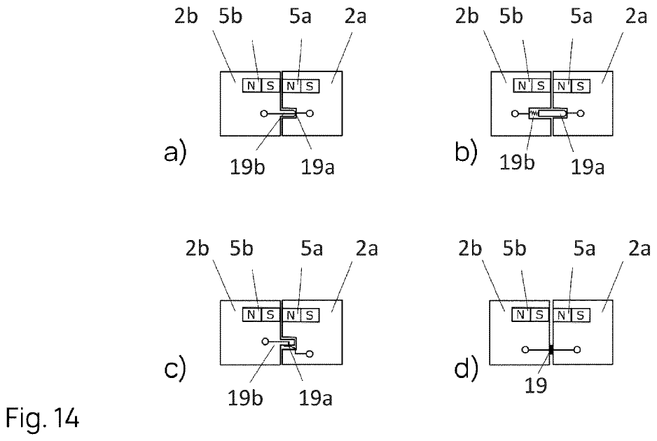

FIG. 14 various exemplary designs of contact elements,

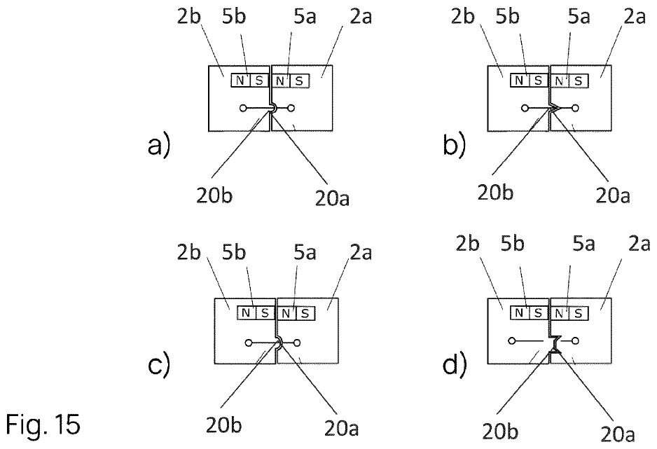

FIGS. 15a) to 15d) exemplary embodiments of the contact elements,

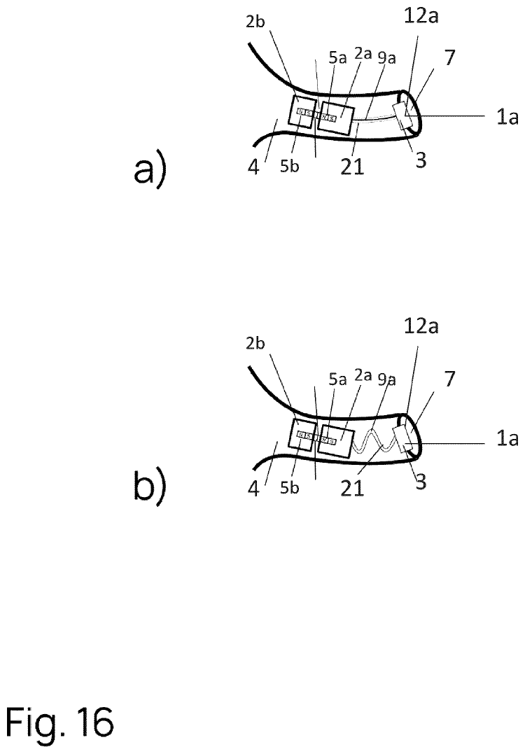

FIGS. 16a) and 16b) an exemplary embodiment of the invention,

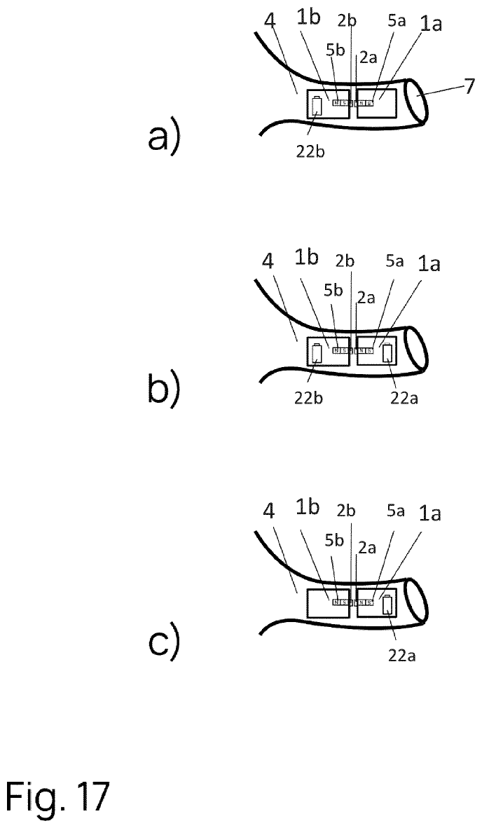

FIGS. 17a) to 17c) embodiments of a hearing system according to the invention,

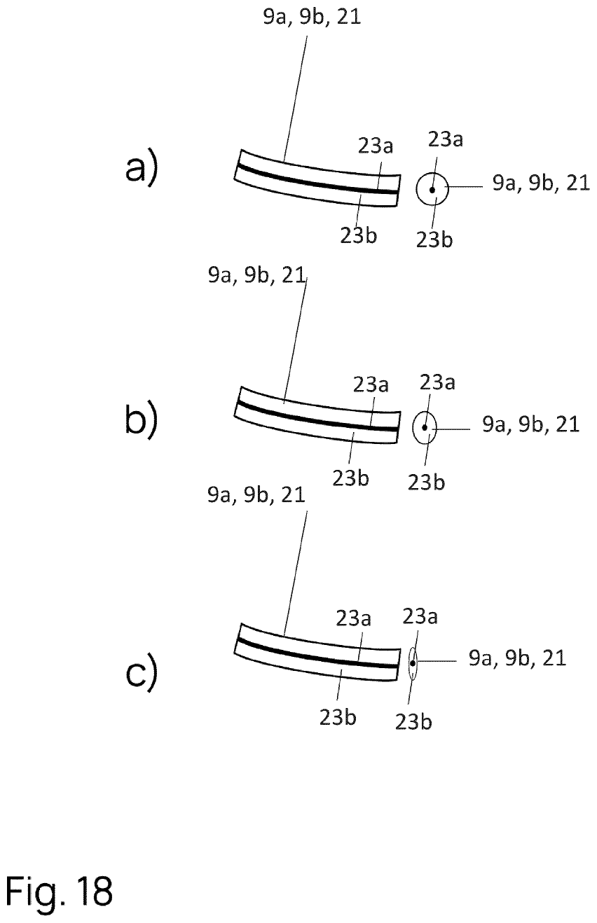

FIGS. 18a) to 18c) cross-sections of cables or optical fibers,

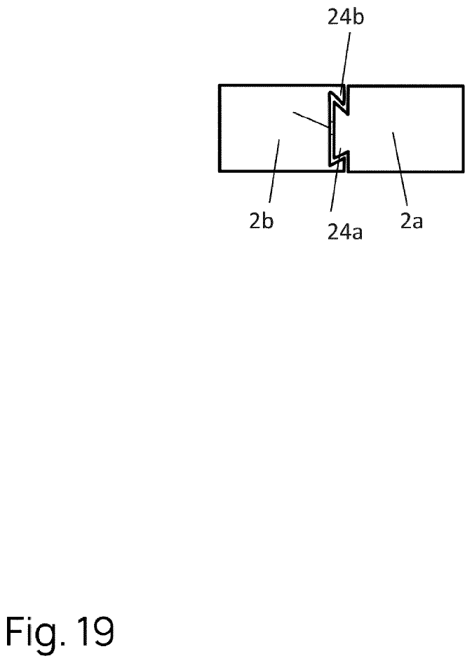

FIG. 19 an embodiment of the first contact element and the second contact element,

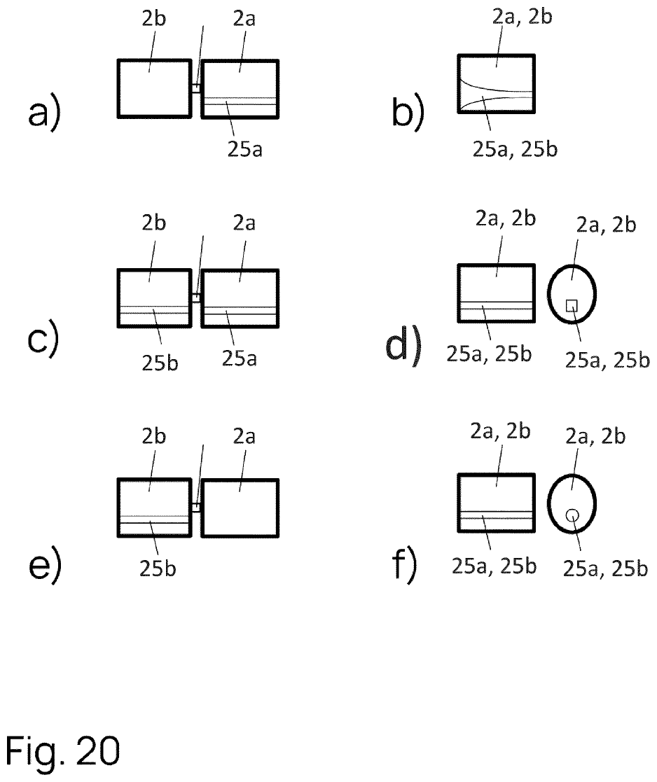

FIGS. 20a) to 20f) embodiments of the first and second contact elements with different combinations of through-openings,

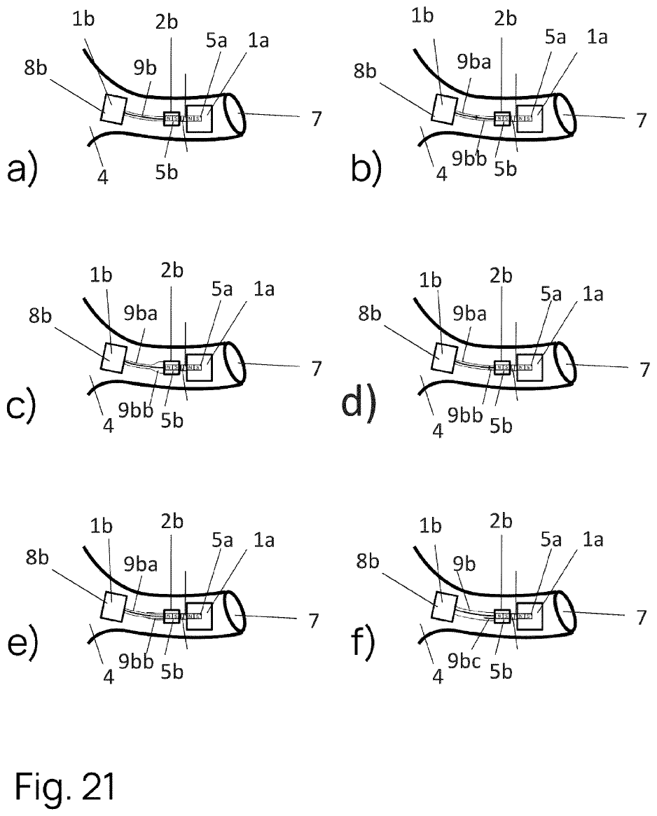

FIGS. 21a) to 21f) embodiments of the hearing system according to the invention,

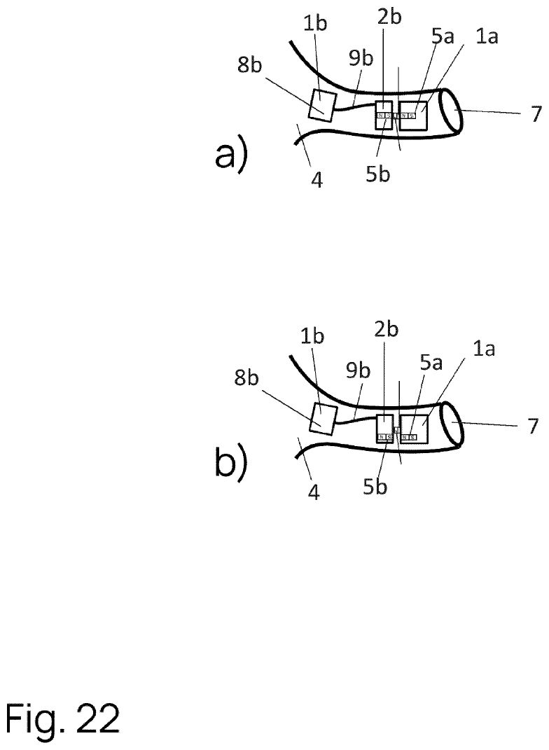

FIGS. 22a) and 22b) an embodiment of the invention such as that shown in FIG. 21a), in which the second device has an external component in addition to the contact element,

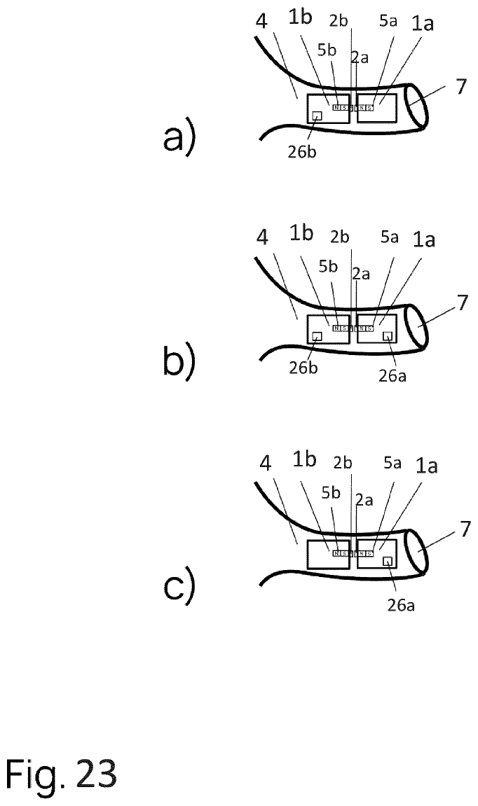

FIG. 23 various embodiments of an exemplary hearing system according to the invention,

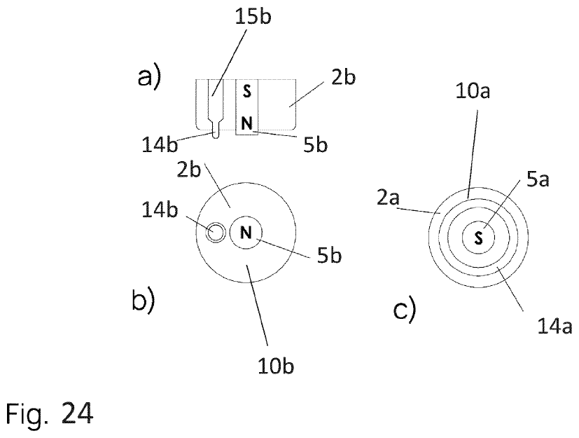

FIGS. 24a) to 24c) embodiments of the first contact element and the second contact element, each of which has a magnetic force element in its center,

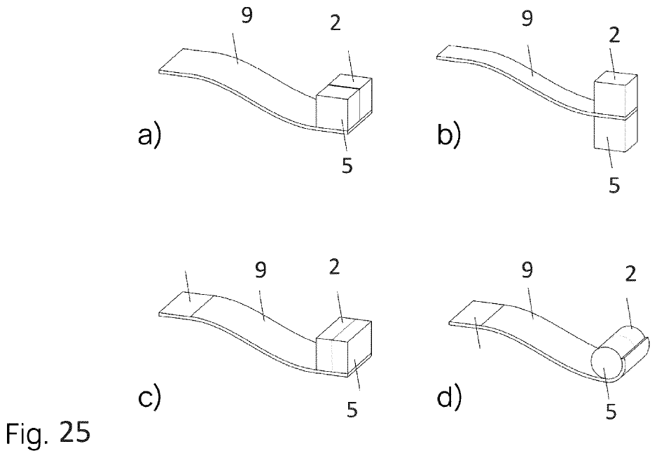

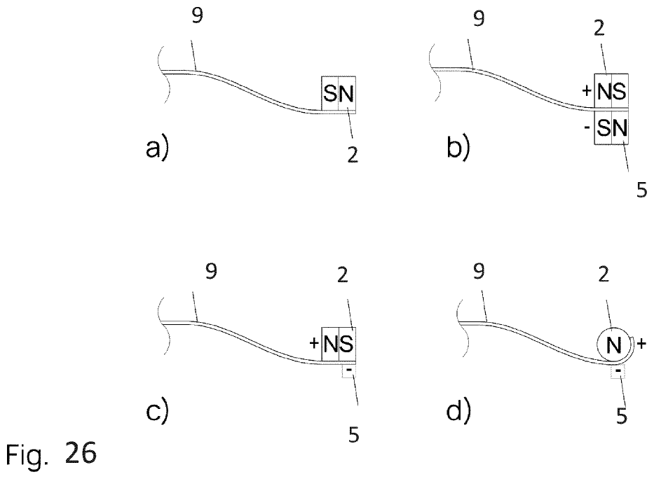

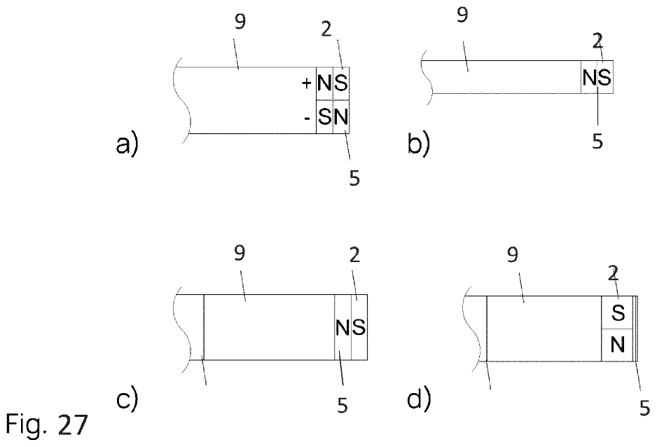

FIGS. 25 to 29 embodiments of cables with magnetic force elements, as can be used in FIG. 5, for example,

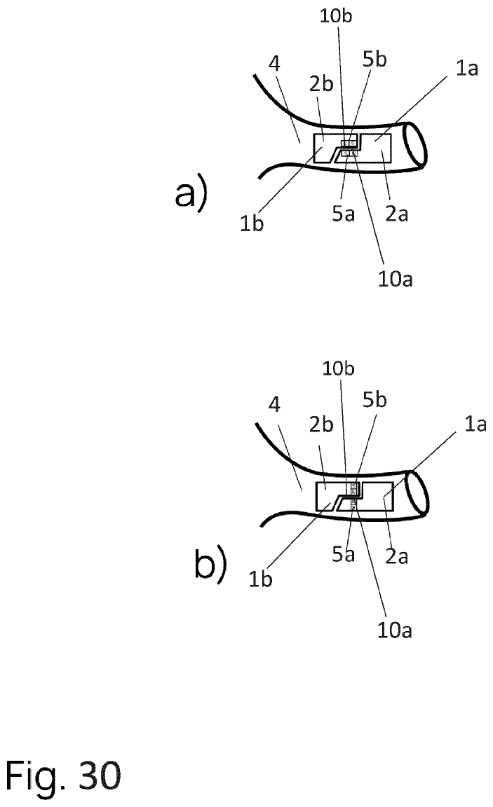

FIGS. 30a) and 30b) embodiments of contact elements,

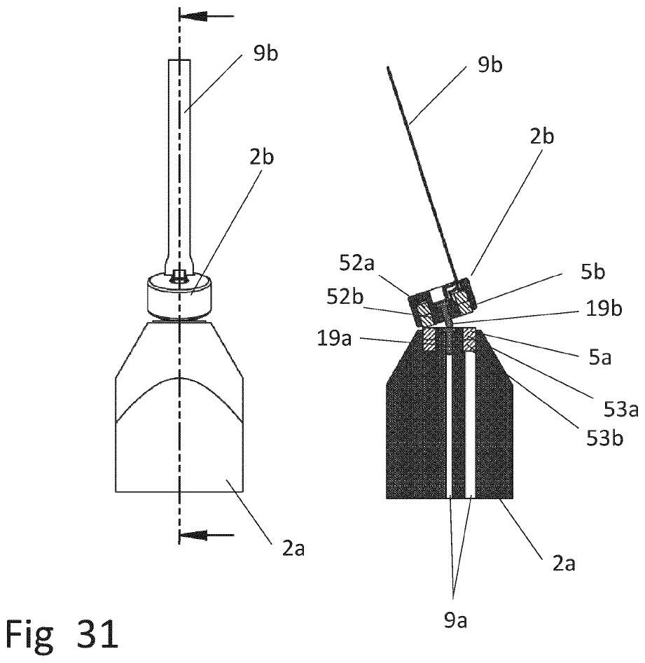

FIG. 31 contact elements with ring magnet force elements,

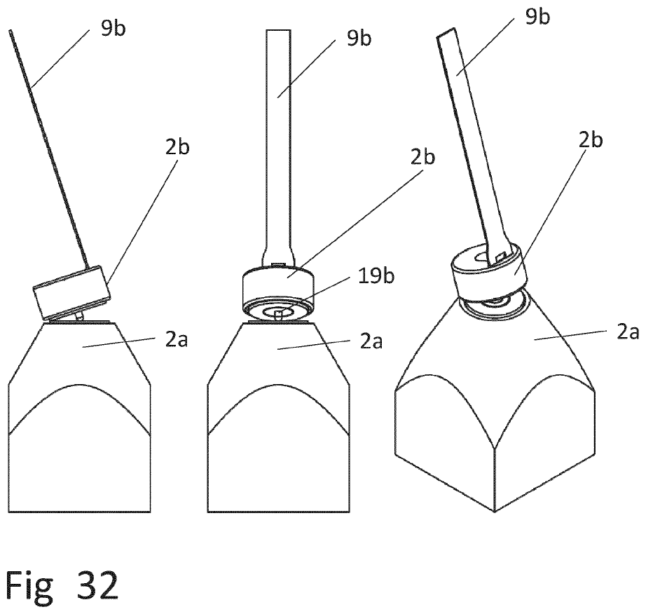

FIG. 32 contact elements with cube-shaped magnetic force elements.

FIG. 1 shows an example of a hearing system 3 according to the invention comprising a first device 1a and a second device 1b. The first device 1a is arranged in the ear canal 4 of a person. In the example shown, the second device 1b is also arranged in the ear canal 4. The first device 1a has a first contact element 2a, and the second device 1b has a second contact element 2b. The first contact element 2a and the second contact element 2b contact each other in order to transfer energy and/or data between the first device 1a and the second device 1b when they contact each other. The first contact element 2a and the second contact element 2b are held in contact with each other by a magnetic force. For this purpose, the first device 1a has a first magnetic force element 5a, and the second device 1b has a second magnetic force element 5b. The first magnetic force element 5a and the second magnetic force element 5b are set up to exert a magnetic force on each other. In the example shown in FIG. 1, the first and second magnetic force elements 5a, 5b are both magnets. However, it is also possible that only one of the two magnetic force elements 5a or 5b is a magnet and the other magnetic force element 5a or 5b contains or consists of magnetizable material.

In FIG. 1, the first device 1a is arranged facing an eardrum 7, while the second device 1b is arranged facing an auricle 6, i.e. an outer side of the ear canal 4.

FIG. 2 shows another example of a hearing system 3 according to the invention. In this example, the second device 1b has, in addition to the contact element 2b, a further element 8b, which is connected to the contact element 2b via a cable 9b. In this example, the first device 1a is identical to the first contact element 2a.

The first contact element 2a and the second contact element 2b each have a contact surface 10a, 10b, which face each other and via which the first and second contact elements mutually-facing bear against each other. The contact surfaces 10a and 10b lie parallel to each other and in this example are inclined with respect to a passage direction of the ear canal 4, so that they are neither parallel nor perpendicular to this passage direction, but form an angle greater than 0° and less than 90°. If we consider a straight line that runs parallel to the wall of the ear canal 4 at the location of the contact surface 10a, 10b, the contact surfaces 10a and 10b can form an angle of greater than 0° and less than 90° with this straight line. In the example shown, the angle to this straight line is approximately 50°. In general, this angle can preferably be less than 80°, particularly preferably less than 70°, more preferably less than 60°, optionally also less than 40° or less than 30°.

In the example shown, the first contact element 2a and the second contact element 2b each have two magnetic force elements 5a and 5b respectively. In this example, the north-south directions of these are perpendicular to the respective contact surface 10a, 10b. In addition, the north-south directions of all these magnetic force elements 5a, 5b are parallel to each other here. The magnetic force elements 5a of the first contact element 2a are polarized in opposite directions, so that one assigns its north pole to the contact surface 10a of the first contact element 2a and the other magnetic force element assigns its south pole. Accordingly, the magnetic force elements 5b of the second contact element 2b are also polarized in opposite directions, so that the first magnetic force element assigns its south pole to the contact surface 10b of the second contact element 2b and the other magnetic force element assigns its north pole. One magnetic force element 5a lies on an extension of the north-south direction of one of the magnetic force elements 5b in such a way that in each case a north pole facing the contact surface 10a bears against a south pole facing the contact surface 10b and a south pole facing the contact surface 10a bears against a north pole facing the contact surface 10b, so that the contact elements 2a and 2b are held together by the magnetic force effect of the magnetic force elements 5a and 5b.

Due to the inclined position of the contact surfaces 10a and 10b, the first contact element 2a can be separated from the second contact element 2b by exerting tension on, for example, the cable 9b or the further element 8b of the second device 1b arranged outside the ear. The second contact element 2b can slide along the contact surface 10a and thereby separate from the contact surface 10a.

In the example shown, the further element 8b of the second device 1b is an outer element 8b, which is arranged outside the ear canal 4, in this case on the auricle 6. It is connected to the second contact element 2b via the cable 9b, via which data and/or energy can be transmitted. In this example, the contact element 2b functions as an ear canal element, which is arranged in the ear canal.

In the example shown in FIG. 2, the first device 1a or the first contact element 2a has an anchoring component 11 with which the first device 1a or the first contact element 2a is anchored in the ear canal 4. The anchoring component 11 is formed here by protrusions or bristles 11, which are arranged on the surface of the first device 1a or the first contact element 2a. In the example shown in FIG. 2, they are positioned in such a way that an angle between one of the bristles 11 and the surface of the first device 1a or the first contact element 2a forms an acute angle, the apex of which points in the direction of the eardrum 7.

FIGS. 3a) and 3b) show alternative arrangements of magnetic force elements 5a, 5b of the first device 1a and the second device 1b.

In FIG. 3a), the magnetic force element 5a of the first device 1a has two magnets whose north-south direction is perpendicular to the contact surface 10a and whose north-south direction is arranged essentially in the direction of passage through the ear canal 4. The magnets are polarized in opposite directions, so that the upper magnet in FIG. 3a) has its north pole facing the second device 1b, while the lower magnet has its south pole facing the second device 1b. Accordingly, the second device 1b has two magnetic force elements 5b arranged with parallel north-south directions, each of which lies on the extension of a north-south direction of one of the magnetic force elements 5a of the first device 1a. In each case, a north pole of one of the first magnetic force elements 5a is assigned a south pole of the corresponding magnetic force element 5b, and a south pole of the magnetic force element 5b is assigned to the north pole of the magnetic force element 5a. As in FIG. 1, the contact elements 5a, 5b protrude from the corresponding contact surface 10a, 10b of the first device 1a or the second device 1b. The contact elements 2a and 2b are arranged on a straight line on which the north-south directions of the magnets of the magnetic force elements 5a and 5b also lie.

In FIG. 3b), the first device 1a has a permanent magnet 5a as the magnetic force element 5a, which is arranged with its north-south direction essentially in the direction of passage of the ear canal 4. The second device 1b has an electromagnet 5b as the magnetic force element 5b, which is represented here by a coil. The electromagnet 5b is oriented so that its north-south direction lies on an extension of the north-south direction of the magnetic force element 5a of the first device 1a. As in FIGS. 1 and 3a), the contact elements 2a and 2b are arranged on a straight line on which the north-south direction of the magnetic force elements 5a and 5b also lies.

FIGS. 4a), b) and c) show various embodiments of hearing systems according to the invention. The basic structure corresponds to that of FIGS. 1 and 3b).

FIGS. 4a) to 4c) show various alternatives for arranging anchoring components 11 on first device 1a, second device 1b or first contact element 2a and/or second contact element 2b.

In FIG. 4a), the first device 1a has an anchoring component 11, which is formed here by bristles that are arranged on the surface of the first device 1a and contact an inner wall of the ear canal 4 and support the first device 1a there. The second device 1b in FIG. 4a) has no anchoring component. This constellation is particularly useful if the device 1a is to remain in the ear canal for a long time or permanently, while the second device 1b is to be removable, for example without the assistance of a doctor.

FIG. 4b) shows an embodiment in which the first device 1a has an anchoring component 11a and the second device 1b has a further anchoring component 11b. Both devices 1a, 1b therefore each have an anchoring component 11a, 11b. The anchoring components 11a and 11b are also formed here by bristles on the upper side of the corresponding device 1a, 1b, which are supported on the inner wall of the ear canal 4.

FIG. 4c) shows an embodiment of the hearing system 3 according to the invention in which only the second device 1b has an anchoring component 11 on its outer side. Here too, this is formed by bristles on the surface of the second device 1b. The bristles in turn rest against the inner wall of the ear canal 4.

In FIGS. 4a) to 4c), the bristles are inclined away from the eardrum, starting from the surface of the corresponding device 1a, 1b.

In FIGS. 4a) to 4c), the two devices 1a and 1b are each held in contact with each other by a magnetic force element 5a, 5b. The magnets of the magnetic force elements 5a and 5b lie with their north-south axes on a common straight line that runs essentially parallel to the wall of the ear canal 4.

FIGS. 5a) to 5c) show embodiments of the hearing system 3 according to the invention, in which the first device 1a or the second device 1b has a further element in addition to the contact element 2a, 2b.

In FIG. 5a), in addition to the contact element 2a, the first device 1a has a further component 12a, which faces the eardrum 7 and is connected to the first contact element 2a via a cable 9a.

FIG. 5b) shows an embodiment in which the second device 1b has, in addition to the contact element 2b, a further element 12b which is connected to the contact element 2b via a cable 9b. The further element 12b is arranged on the side of the contact element 2b facing away from the eardrum 7, but still in the ear canal 4. However, the further element 12b can also be arranged outside the ear canal 4, as shown in FIG. 2. In the first device 1a, the first contact element 2a coincides with the first device 1a.

FIG. 5c) also shows an embodiment in which, as in FIG. 5a), the second device 1b coincides with the second contact element 2b and the first device 1a in turn has a contact element 2a and a further element 12a, which is connected to the contact element 2a via a cable 9a. In the example shown in FIG. 5c), the further element 12a of the first device 1a is an eardrum module 12a arranged on the eardrum 7. For example, it can be an actuator, with which vibrations can be applied to the eardrum 7. As shown in FIG. 5d, the further element of the first device 1a can also have, in addition to the eardrum module 12a, an intermediate element 51 that is connected on the one hand, for example via a cable 9a, to the contact element 2a and that is connected on the other hand, for example via a cable 9c, to the eardrum module 12a. The intermediate element 51 can advantageously be accommodated in the ear canal with an anchoring component 11. This embodiment can also be understood on the basis of FIG. 5a). There, the further component 12 can have the intermediate element 11 on the distal side and the eardrum module 12a on the proximal side on the eardrum 7. The second device 1b can be arranged in the ear canal, as shown in FIG. 5c). However, it can be arranged far enough out that it can be easily removed from the outside. The device 1a can remain in the ear canal. In this embodiment, it is advantageous if the magnetic elements 5a and 5b exert a magnetic force on each other that is sufficiently large to keep the devices 1a and 1b in contact with each other, but small enough to allow the second device 1b to be removed without removing the further device 12a of the first device 1a from the eardrum 7.

FIGS. 6a) to 6d) show various embodiments of the first 2a and second 2b contact element with different arrangements of magnetic force elements 5a, 5b and contacts 14a, 14b. In addition, the contact elements 2a, 2b have different sheathings 13.

The sheathings 13 shown in FIGS. 6a) to 6d) completely surround the corresponding contact element 2a, 2b with the exception of the contact 14a, 14b. In FIGS. 6a) and 6b), both contact elements 2a, 2b have such a sheathing 13. In FIG. 6c) only the first contact element 2a has such a sheathing 13 and in FIG. 6d) only the second contact element 2b has such a sheathing 13.

The sheathing 13 can, for example, be corrosion-resistant and/or biocompatible. Preferably, it is non-magnetizable and non-magnetic. For example, the sheathing 13 may comprise or consist of gold, platinum, iridium, an alloy of the aforementioned materials and/or plastic such as silicone and/or parylene. It can also contain or consist of ceramic.

In FIGS. 6a) to 6d), a magnet is provided as the magnetic force element 5a and 5b. The magnets 5a and 5b are arranged with their north-south directions on a common straight line. In addition, a north pole of one of the magnetic force elements 5a, 5b faces a south pole of the other magnetic force element 5a, 5b, so that the magnetic force elements 5a and 5b exert an attractive magnetic force on each other.

In FIG. 6a), the magnetic force elements 5a, 5b are positioned centrally so that their north-south directions are perpendicular to a center of a respective contact surface of the contact element 2a, 2b, with which the contact element 2a, 2b bears against the other contact element 2b, 2a. In FIG. 6a), the contacts 14a, 14b are also arranged in the centers of these contact surfaces bearing against one another, so that the magnetic force elements 5a, 5b are located exactly behind the contacts 14a, 14b from the perspective of the respective other contact element 2a, 2b.

FIG. 6b) shows an example where the magnetic force elements 5a, 5b again lie with their north-south directions on a common straight line, but are arranged at the edge of the corresponding contact element 2a, 2b. In the example shown in FIG. 6b), the contacts 14a, 14b are each arranged on the edges of the contact elements 2a, 2b opposite the magnetic force elements 5a, 5b. The north and south poles of the magnetic force elements 5a and 5b are again oriented in such a way that they exert an attractive force on each other. In the contacted state, the contacts 14a and 14b are in contact with each other so that data and/or current can be transmitted via them.

In FIGS. 6c) and 6d), the magnetic force elements 5a, 5b and the contacts 14a, 14b are arranged as in FIG. 6b), so that reference should be made to the description there.

FIGS. 7a) to 7c) show embodiments of the invention in which the first 2a and/or the second contact element 2b has, on a contact surface facing the respective other of the contact elements 2a, 2b in the contact shown, at least one contact pin 14a, 14b or spacer element 14a, 14b which, in the contacted state, determines a distance between the at least one first 2a and the at least one second 2b contact element at the location of the contact pin/spacer element 14a, 14b. Preferably, the contact pins/spacer elements 14a, 14b may have a height perpendicular to that surface of the contact element 2a, 2b on which they are arranged, which is smaller than a diameter of this contact element 2a, 2b in the direction parallel to this surface. In general, the spacer elements can advantageously act as contact pins via which data and/or energy can be transmitted.

In FIG. 7a), only the first contact element 2a has a first spacer element 14a. This makes contact with the surface of the second contact element 2b that faces the first contact element 2a. In the example shown in FIG. 7b), both contact elements 2a and 2b each have a contact pin 14a, 14b. The contact pins 14a and 14b touch each other with their surfaces that face away from the corresponding contact elements 2a, 2b on which they are arranged.

FIG. 7c) shows an embodiment in which only the second contact element 2b has a spacer element 14b that contacts the surface of the first contact element 2a that faces the second contact element 2b.

FIG. 7c) also shows the arrangement of the magnetic force elements 5a, 5b in this example. These are not shown in FIGS. 7a) and 7b), but can be arranged in exactly the same way. The magnetic force elements are arranged directly behind the contact pin 14a, 14b and face each other with opposite poles so that they attract each other.

FIGS. 7a) to 7c) show only the contact elements 2a, 2b with the contact pins 14a, 14b. The other elements of the hearing system have been omitted for the sake of clarity and can be designed as shown in the other figures. Advantageously, the energy and/or data can be transmitted via the contact pins 14a, 14b, i.e. they can establish an electrical contact.

FIGS. 8a) to 8c) show different views of an exemplary embodiment of one of the contact elements 2a with two contact pins 14ab, 14bb, via which electrical contact can be made. FIG. 8a) shows a section along a plane that intersects the center of the contact element. Two electrical contacts 15aa, 15ab extend through the contact element 2a and form two contact pins 14aa and 14ab on the side facing the other contact element 2b (not shown here). The contact pins 14aa, 14ab extend beyond the magnetic element 5a, i.e. they protrude beyond the magnetic element 5a. Their height on the contact surface of the contact element 2a facing the other contact element 2b is therefore greater than the height of the magnetic force element 5a on this surface. FIG. 8b) shows a top view of the contact surface of contact element 2a that faces the other contact element. It can be seen here that the contact pins 14aa and 14ab are diametrically opposite each other in relation to the center of the contact surface of the contact element 2a. The magnetic force element 5a is arranged exactly in the center here.

FIG. 8c) shows a section of the view shown in FIG. 8b) in a plane that is vertical between the contact pins 14aa and 14ab and perpendicular to the plane of the figure.

FIGS. 9a) to 9c) show a further exemplary embodiment of a contact element 2a. This is designed as shown in FIG. 8 with the difference that two magnetic force elements 5aa, 5ab are provided here. These are both designed as permanent magnets and are arranged parallel to each other with their north-south directions oriented in opposite directions. While the magnetic force element 5a in FIG. 8 is arranged in the center of the contact element 2a, the magnetic force elements 5aa and 5ab in FIG. 9 are arranged diametrically opposite each other with respect to the center of the contact element 2a. Their north-south directions are perpendicular to the surface of the contact element 2a that faces the other contact element 2b when used as intended. The contact pins 14aa and 14ab are arranged as shown in FIG. 8 and are connected to electrical contacts 15aa, 15ab, which extend through the contact element 2a. In FIG. 8 and FIG. 9, the contacts 15aa, 15ab run parallel to the north-south direction of the magnetic force elements 5aa, 5ab. FIGS. 10a) to 10c) show an exemplary embodiment of the first contact element 2a, which corresponds to that of FIGS. 9a) to 9c) with the exception of an additional protective element 16a. In FIGS. 10a) to 10c), the protective element 16a is arranged centrally on that surface of the contact element 2a that faces the other contact element 2b and has a height that is higher than the height of the electrical contactings 14aa, 14ab, which protrude above said surface. In this way, the protective element 16a prevents a user from touching the contacts 14aa and 14ab with his finger at the same time. The protective structure 16a is approximately cylindrical in shape and its central axis is perpendicular to the said contact surface 10a of the contact element 2a. The contact pins 14aa and 14ab are arranged diametrically opposite each other in relation to the protective element 16a.

FIGS. 11a) to 11c) show an exemplary embodiment of a contact element 2b that can be used as a counterpart to the contact element 2a shown in FIG. 10. As can be seen in FIG. 11a), the contact element 2b has two electrical feedthroughs 15ba, 15bb, which extend through the contact element 2b from the contact surface 10b assigned to the contact element 2a to the opposite surface. On the contact surface 10b that faces the contact element 2a when used as intended, the contact element 2b has two recesses 14ba, 14bb, as shown in FIG. 11b), into which the contact pins 14aa, 14ab can engage when the contact elements 2a, 2b are arranged together. In the example shown, the contact element 2b has a recess 16b between the recesses 14ba and 14bb, into which the protective structure 16a or the protective element 16a can engage when the contact elements 2a and 2b are arranged in contact with one another. The recess 16b is exactly centered on the contact surface 10b of the contact element 2b that faces the contact element 2a. The magnetic force elements 5ba, 5bb are arranged diametrically opposite each other at equal distances from the center of the contact element 2b with a distance from the center that is equal to the distance at which the magnetic force elements 5aa, 5ab of the contact element 2b shown in FIG. 10 are arranged.

FIGS. 12a) and 12b) show an embodiment of the invention in which the first contact element 2a and the second contact element 2b each have two magnets 5aa, 5ab, 5ba, 5bb whose poles are arranged such that magnets of different contact elements 2a, 2b attract one another (FIG. 12a)) when the contact elements 2a, 2b are in a position relative to one another in which energy and/or data can be transmitted between the first device 1a and the second device 1b, and such that they repel one another (FIG. 12b)) when they are in a position relative to one another in which no energy and/or data can be transmitted. In the example shown, contact element 2b has a protective structure 16a or a protective element 16a which can engage in a recess 16b in contact element 2a when contact elements 2a and 2b are in contact with each other as shown in FIG. 12a). The structures 16a and 16b can also be a contact pin 16a and a contact surface 16b. In the example shown in FIG. 12, the height of the protective structure 16a minus the depth of the recess 16b is greater than the sum of the heights with which the magnetic force elements 15aa, 15ab, 15ba, 15bb protrude above the contact surface of the contact element 2a, 2b on which they are arranged. This results in the tilting of the contact elements 2a, 2b with respect to one another as shown in FIG. 12a), which enables the contact elements 2a, 2b to be released by pulling on the contact elements 2a and/or 2b.

FIGS. 13a) to 13d) show various options for transferring energy and/or data between the contact elements 2a and 2b.

In the example shown in FIGS. 13a) to 13d), the contact elements 2a and 2b each have a magnetic force element 5a, 5b. The magnetic force elements 5a, 5b are arranged laterally and have opposite north-south directions as described above. The north-south directions of the two magnetic force elements 5a, 5b lie on a common straight line.

In FIG. 13a), the first contact element 2a has a first coil 17a and the second contact element 2b has a second coil 17b. The coils 17a and 17b are arranged so that they can transfer energy to each other when the contact elements 2a and 2b are in contact with each other. The coil axes lie on a common straight line. The coils 17a and 17b are each arranged directly behind or in the contact surface with which the corresponding contact element 2a, 2b faces the other contact element 2b, 2a.

In FIG. 13b), the second contact element 2b has a light-emitting diode 17b, opposite which a photodiode 17a is arranged in the contact element 2a. In this way, energy and/or data can be transmitted to the Photodiode 17a by means of the light-emitting diode 17b. The light-emitting diode 17b and the Photodiode 17a are arranged relative to each other in such a way that light from the light-emitting diode 17b can enter the photodiode 17a on contact.

FIG. 13c) shows a capacitive transmission of energy and/or data between the contact element 2a and the contact element 2b. For this purpose, the contact elements 2a and 2b each have a plate 17a, 17b, whereby the plates 17a and 17b form a capacitor when the contact elements 2a and 2b make contact as intended.

FIG. 13d) shows an optical transmission of data and/or energy like that shown in FIG. 13b). Unlike in FIG. 13b), however, the light-emitting diode 17b is not arranged here directly in the contact surface of the contact element 2b, which faces the contact element 2a, but rather an optical fiber 18 is arranged in the contact surface of the contact element 2b, which optical fiber extends in the direction perpendicular to this contact surface and at the end of which facing away from the contact surface the light-emitting diode 17b is arranged in such a way that it can radiate light into the end of the optical fiber 18 that faces it.

FIG. 14 shows various exemplary embodiments of contact elements 2a, 2b, which are galvanically contacted for data and/or energy transmission. The arrangement of the magnetic force elements 5a, 5b is as shown in FIG. 13. Reference is made to the description thereof.

In FIG. 14a), the first contact element 2a has a socket 19a, which is electrically contacted. The contact element 2b has a plug 19b which, when properly contacted, projects into the socket 19a and establishes an electrical contact between the contact elements 2a and 2b.

In FIG. 14b), the first contact element 2a also has a socket 19a. The second contact element 2b has a plug 19b, which is spring-loaded. It has a movable element that is guided into a recess in the second contact element 2b. A spring is arranged between a base of the recess and this movable element, which presses the movable element in the direction of the contact element 2b.

FIG. 14c) shows an embodiment of a contact in which the first contact element 2a has a socket with a spring contact 19a. A plug 19b of the second contact element 2b protrudes into the socket. The spring contact 19a is pressed against the plug 19b of the second contact element 2b by its spring force, thereby establishing an electrical contact.

Finally, FIG. 14d) shows an embodiment in which the contact between the contact element 2a and 2b is an exposed electrode contact 19. To create this, the contact elements 2a and 2b can have a contact surface on their contact surface that faces the respective other contact element 2b, 2a, so that these contact surfaces touch each other during intended contact.

FIGS. 15a) to 15d) show exemplary embodiments of the contact elements 2a and 2b, wherein of two surfaces of the first and second contact elements 2a, 2b that can be brought into contact with one another, one surface has at least one concave region 20a and the other surface has at least one convex region 20b. The convex region 20b protrudes into the concave region 20a. Electrical contact is made between the first contact element 2a and the second contact element 2b in the region of the concave or convex surface 20a, 20b. These regions are arranged next to the magnetic force elements 2a, 2b, which are arranged laterally away from the center of the contact elements 2a, 2b. In FIG. 15a) the convex 20b and concave 20a regions are spherical-segment-shaped, in FIG. 15b) conical, in FIG. 15c) ellipsoid-segment-shaped and in FIG. 15d) crown-shaped.

FIGS. 16a) and 16b) show an embodiment of the invention, wherein the first device 1a has an eardrum component 12a that can be arranged on the eardrum 7 in contact with the latter and is configured to transmit vibrations directly to the eardrum 7. In FIG. 16a) and 16b), it is connected to the first contact element 2a via a cable 9a.

In the example shown in FIG. 16a), the cable 9a has a wire 21. The cable 9a can also be a strip conductor 21 arranged on a flexible printed circuit board. The wire 21 or the printed circuit board 21 are preferably insulated from the environment by means of an insulating material. In a particularly advantageous embodiment, the wire or the printed circuit board 21 can be a layer comprising or consisting of gold on a polyimide substrate.

FIG. 16b) shows a corresponding embodiment to FIG. 16a) with the difference that here the cable 9a is flexible and spiral-shaped so that a distance between the first contact element 2a and the element 12a of the first device 1a arranged at the other end of the cable can be varied elastically.

FIGS. 17a) to 17c) show embodiments of a hearing system according to the invention, in which the second device 1b has an ear canal element that is arranged in the ear canal and that has the second contact element 2b. The ear canal element here can be the device 1b itself or can be connectable to or connected to an outer element 8b as shown in FIG. 2, for example. In FIG. 17a), the second device 1b or the ear canal element has a rechargeable battery 22b, so that the second device 1b can be operated without an external energy supply.

In FIG. 17b), the first device 1a has a rechargeable battery 22a and the second device 1b has a rechargeable battery 22b.

In FIG. 17c), only the first device 1a has a rechargeable battery 22a. The contact elements 2a and 2b as well as the magnetic contacting are designed in FIG. 17 as shown in FIG. 4, for example, so that reference should be made to the description thereof.

In various embodiments of the invention, cables 9a, 9b, 21 or optical fibers 9a, 9b, 21 can be used to connect different parts of the first device 1a and/or different parts of the second device 1b. FIGS. 18a) to 18c) show embodiments of the cables 9a, 9b, 21 or the optical fibers 9a, 9b, 21, which have a tube 23b or a sheathing material 23b. This can preferably be chemically resistant, electrically insulating and/or mechanically flexible and particularly preferably can contain or consist of a thermoplastic, polyamide, silicone and/or an epoxy. The tube 23b and/or the sheathing material 23b encase a wire 23a or optical fiber 23a.

In each of FIGS. 18a) to 18c), the left-hand partial image shows a cross-section along a longitudinal axis of the cable or optical fiber 9a, 9b, 21, while the right-hand partial image shows a cross-section perpendicular to the longitudinal axis.

In FIG. 18a), the cable or optical fiber formed in this way has a circular cross-section. In FIGS. 18b) and 18c), the tube 23b has an elliptical or flat cross-section, the shorter dimension of which is approximately 50% of the longer dimension in FIG. 18b) and less than 75% of the longer dimension in FIG. 18c).

FIG. 19 shows an embodiment of the first contact element 2a and the second contact element 2b, with the first contact element 2a having a radial protrusion 24a. This means that the contact element 2a has a protrusion on its contact surface that faces the contact element 2b, which protrudes in the radial direction beyond the contact surface of the contact element 2a facing the contact element 2b. The protrusion therefore tapers in the direction of the contact surface of the contact element 2a that faces the contact element 2b. The second contact element 2b accordingly has a radial undercut 24b, into which the radial protrusion 24a engages. In this way, the radial protrusion 24a is held in the radial undercut 24b. The radial undercut 24b is designed here as a recess in the contact surface of the contact element 2b that faces the contact element 2a, whereby the radial extent of the recess increases with in-creasing depth.

Radial extension is understood to be the distance from the center axis of the contact element 2a or 2b.

FIGS. 20a) to 20f) show embodiments of the first 2a and second 2b contact elements with different combinations of through-openings 25a, 25b, which extend through the first contact element 2a and/or the second contact element 2b. The through-openings 25a, 25b shown in FIGS. 20a) to 20f) can also be provided in the first device 1a and/or the second device 1b accordingly.

In FIG. 20a), only the first contact element 2a has a through-opening 25a, which is perpendicular to the contact surface of the first contact element 2a. In FIG. 20c), the first contact element 2a has a through-opening 25a that is perpendicular to the contact surface of the first contact element 2a, and the second contact element 2b has a through-opening 25b that is perpendicular to the contact surface of the second contact element 2b. When the first contact element 2a makes contact with the second contact element 2b, the through-openings 25a and 25b are arranged here with their through directions on a common straight line. In FIG. 20e), only the second contact element 2b has a through-opening 25b, which is perpendicular to the contact surface of the second contact element 2b.

FIG. 20b) shows an optional embodiment of the through-opening 25a and/or 25b. The through-opening 25a, 25b is funnel-shaped here and tapers from the left-hand surface of the corresponding contact element 25a, 25b to the right-hand upper side. The through-opening 25a, 25b therefore opens on the left-hand side with a larger average than on the right-hand side of the contact element 2a, 2b.

FIG. 20d) shows an embodiment of the through-opening 25a, 25b, which, as can be seen in the right-hand partial image, has a square cross-section. FIG. 20d) also shows by way of example that the contact element 2a, 2b can have an elliptical cross-section.

Finally, FIG. 20f) shows an example of the through-opening 25a, 25b in the first 2a and/or second 2b contact element, wherein the through-opening 25a, 25b has a circular cross-section. In FIGS. 20d) and 20f), the through-opening is therefore cylindrical, with a square base in FIG. 20d) and a circular base in FIG. 20f).

FIGS. 21a) to 21f) show embodiments of the hearing system according to the invention, in which the second device 1b has an outer element 8b, which is connected to a ear canal element 2b, which here is the contact element 2b. The outer element 8b is arranged further out in the ear canal 4 than the contact element 2b. The outer element 8b is connected to the contact element 2b via a cable 9 or an optical fiber 9b, via which energy and/or data can be transmitted to and/or from the second contact element 2b to the outer element 8b. The cable 9b or the optical fiber 9b has a tube and/or a sheathing material. FIGS. 21a) to 21f) show different embodiments of the cable 9b or the optical fiber 9b.

In FIG. 21a), the cable 9b has a core that is surrounded by the tube or sheathing material. The core can be a wire or an optical fiber.

In FIG. 21b), the cable 9b or optical fiber 9b has two sections 9ba and 9bb, which are made of different materials here. However, sections 9ba and 9bb have the same circumference and diameter.

In FIG. 21c), the cable 9b or the optical fiber 9b has two sections 9ba and 9bb in which the surrounding material/the tube has a different wall thickness. It has a thinner wall thickness in region 9ba than in region 9bb. The cable 9b/the optical fiber 9b adjoins the contact element 2b with the section 9bb of the larger cross-section and the section 9ba of the smaller cross-section adjoins the outer element 8b.

FIG. 21d) shows an embodiment in which the cable 9b/optical fiber 9b has at least two regions 9ba and 9bb of different stiffness (that is, resistance against bending) over its length. In the example shown, the stiffness of the section 9bb that engages the element 2b facing the eardrum 7, in this case the contact element 2b, can be greater than the stiffness of the section that engages the element 8b that faces away from the eardrum 7, in this case the outer element 8b. Alternatively, the stiffness of section 9ba, which engages the outer module 8b, can also be greater than the stiffness in section 9bb, which engages the second contact element 2b.

FIG. 21e) shows an embodiment in which the cable 9b or the optical fiber 9b has a different number of tubes covering the central wire/optical fiber in two sections 9ba and 9bb. In section 9ba, which adjoins the outer element 8b, the cable 9b or the optical fiber 9b has a tube as sheathing and in section 9bb, which adjoins the contact element 2b, it has two tubes.

FIG. 21f) shows an embodiment in which the wire 9b/optical fiber 9b has a stabilizing component 9bc in its end that faces the contact element 2b. The stabilizing component 9bc is designed here as a piece of wire that extends from the end adjacent to the second contact element 2b in the sheathing material or tube over part of its length. In order to enable the arrangement of the stabilizing component 9bc, the wire or the optical fiber can be slightly offset in the sheathing material relative to the central axis, so that a region is created in which the stabilizing component 9bc can be accommodated.

The other elements in FIG. 21 correspond to those shown in the other figures, so that reference should be made to the description thereof.

FIGS. 22a) and 22b) show an embodiment of the invention such as that shown in FIG. 21a), in which the second device 1b has, in addition to the contact element 2b, an outer component 8b that is connected to the contact element 2b via a cable 9b or an optical fiber 9b. Whereas in FIG. 21a) the cable engages centrally, i.e. in the middle of the second contact element 2b, in FIG. 22a) and 22b) it is offset to the side. The cable 9b or the optical fiber 9b is therefore arranged on the second contact element 2b at a distance greater than zero from a straight line that is perpendicular to the contact surface of the second contact element 2b with the first contact element 2a and that intersects this contact surface at its center. The magnetic force elements 5a and 5b are arranged centrally in FIG. 22a). In FIG. 22b), they are laterally offset, i.e. also spaced apart by a distance greater than zero from the straight line that is perpendicular to the contact surface of the second contact element 1b with the first contact element 2a and that intersects this contact surface at its center.

A corresponding embodiment is also possible for the first device 1a.

FIG. 23 shows various embodiments of an exemplary hearing system according to the invention, in which the first device 1a and/or the second device 1b has a microphone 26a, 26b. In FIG. 23a), the second device 1b has a microphone 26b, while the first device 1a has no microphone. Such a microphone 26b can, for example, pick up sound signals from outside, which can then be transmitted to the first device 1a via the contact elements 2a, 2b.

In FIG. 23b), the first device 1a has a microphone 26a and the second device 1b has a microphone 26b. The microphone 26b of the second device 1b can in turn be used to pick up sounds from outside the ear in order to transmit them to the first device 1a. The microphone 26a of the first device 1a can, for example, be used to pick up sounds in the ear canal 4 and, if necessary, feed them to a signal processing system, for example to generate anti-noise for active suppression of ambient noise.

FIG. 23c) shows an embodiment in which only the first device 1a has a microphone 26a. This can be used as described in FIG. 23b), for example, to record sounds inside the ear canal.

FIGS. 24a) to 24c) show an embodiment of the first contact element 2a and the second contact element 2b, which each have a magnetic force element 5a, 5b in their center. When the first contact element 2a comes into contact with the second contact element 2b, a magnetic force acts between them. In the example shown, the south pole of the magnetic force element 5a of the first contact element 2a faces the second contact element 2b. The north pole of the magnetic force element 5b of the second contact element 2b faces the first contact element 2a, so that these magnetic force elements 5a and 5b attract each other. The polarity of the magnets can of course also be reversed. The magnetic force elements 5a, 5b are each arranged in a center of a contact surface 10a, 10b of the first 2a and the second 2b contact element, via which contact surfaces 10a, 10b the first and second contact elements bear against each other on contact, or which face each other on contact.

FIGS. 24a) and 24b) show the second contact element 2b. This has a contact pin 14b, which is arranged on the contact surface 10b and protrudes from it. The contact pin 14b is arranged eccentrically next to the magnetic force element 5b. It is electrically contacted through the second contact element 2b by an electrical contact 15b.

FIG. 24c) shows a top view of the contact surface 10a of the first contact element 2a. The first contact element 2a has a ring-shaped contact surface 14a on or in its contact surface 10a, which extends in a circular ring around the magnetic force element 5a as the center. The radius of the ring-shaped contact surface 14a is equal to the distance of the contact element 14b of the second contact element 2b from the center of the contact surface 10b of the second contact element 2b and from the center of the magnetic force element 5b. In this embodiment, if the first contact element 2a is brought into contact with the second contact element 2b so that the magnetic force element 5a and the magnetic force element 5b attract each other, the contact pin 14b just makes contact with the contact surface 14a of the first contact element 2a. In this embodiment, the two contact elements 2a, 2b can rotate relative to each other about a central axis that runs through the centers of the contact surfaces 10a and 10b of the contact elements 2a, 2b and at the same time maintain electrical contact, since the contact pin 14b slides on the contact surface 14a.

FIGS. 25 to 27 show in sub-figures a) to d) in each case embodiments of cables 9 as they can be used in the other figures, in particular FIG. 5. The figures show different perspectives of the cables. The cables 9 here are flat cables. These cables 9 can, for example, protrude from the first and/or second device in the direction of the respective complementary device and contact it with a contact element 2 attached to the end of the cable 9. The contact elements 2 are magnetic force elements 5, which can also be used to establish contact. The polarity of the magnetic force elements 5 is shown as an example in each case.

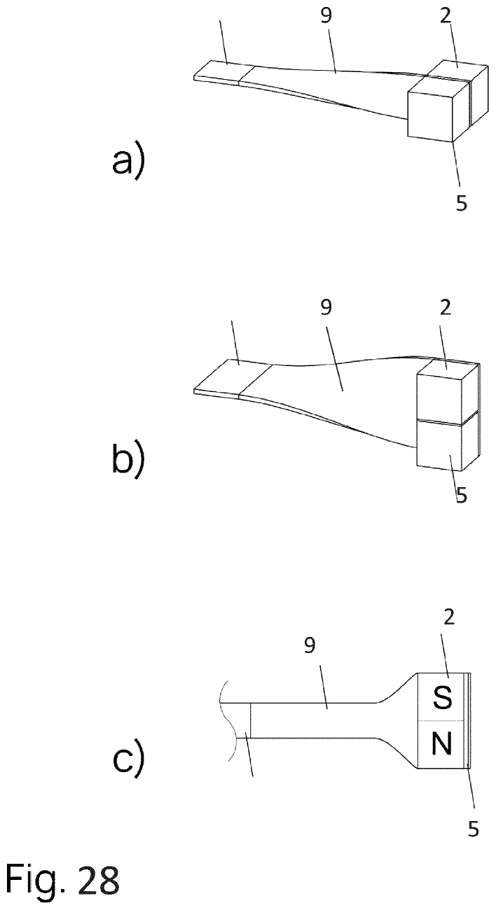

FIG. 28 shows corresponding embodiments of cables 9 as in FIGS. 25 to 27. In FIG. 28a), the cable 9 is arranged between two magnetic force elements 5, which each serve as a contact element. The cable 9 is twisted by 90° around its longitudinal axis. In FIG. 28b), two magnetic force elements at the end of the ribbon cable 9 are arranged next to each other on the same surface of the cable. The cable is again twisted by 90°. In FIG. 28c), the ribbon cable widens along its longitudinal direction in the direction of the magnetic force elements 5, so that a wider contact surface is available for these.

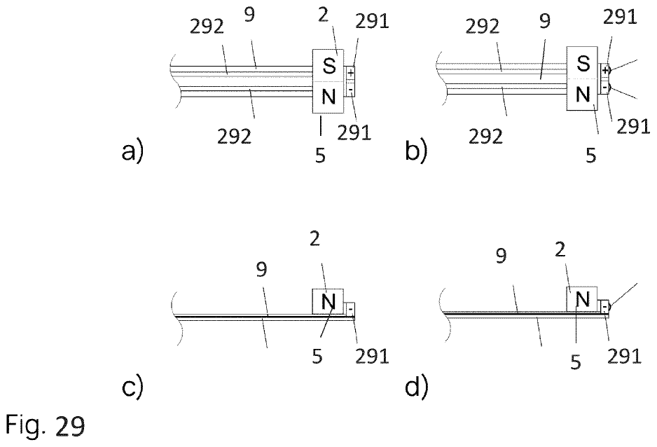

FIG. 29 shows further examples of cables 9 with magnetic force elements 5. The magnetic force elements 9 are arranged near the end of the ribbon cable 9. The end of the cable is formed by contacts 291. These are contacted by strip conductors 292 that run along the cable 9 on its surface. The poles of the magnetic force elements are shown, as are the poles of the contacts 291. The contacts 291 can be used to establish contact for the transmission of energy and/or data.

FIGS. 30a) and 30b) show an embodiment of contact elements 2a, 2b according to an example of the present invention. In this example, the contact elements 2a and 2b each have a contact surface 10a, 10b that runs parallel to the ear canal wall when the contact elements are arranged in the ear canal 4 as intended. The contact surfaces 10a, 10b also run parallel to a passage direction of the ear canal 4. For this purpose, the first contact element 2a has a step in its contact surface 10a, which has a section perpendicular to the direction of passage of the ear canal 4 and then a section parallel to the direction of passage of the ear canal 4. The second contact element 2b also has a step in its contact surface 10b for this purpose, which has a section that is parallel to the direction of passage of the ear canal. The sections of the step of the first contact element 2a and the step of the second contact element 2b, which in the example shown are parallel to the direction of passage of the ear canal 4, lie parallel to each other. In this way, they lie parallel to each other in the ear canal 4 regardless of the orientation of the contact elements 2a, 2b. The first contact element 2a has a first magnetic force element 5a, which is arranged directly behind, in or on that section of the contact surface 10a which runs parallel to the direction of passage of the ear canal 4. The second contact element 2b has a second magnetic force element 5b in, behind or on that part of the contact surface 10b of the second contact element 2b with which the second contact element 2b bears against the contact surface of the first contact element 2a that has the first magnetic force element 5a.

In FIG. 30a), the magnetic force elements 5a and 5b lie with their north-south directions parallel to the section of the contact surface 10a, 10b that runs parallel to the direction of passage of the ear canal 4 and are oriented in opposite directions so that they attract each other.

In FIG. 30b), the magnetic force elements 5a and 5b are perpendicular with their north-south directions to those sections of the contact surfaces 10a, 10b of the first contact element 2a and second contact element 2b that run parallel to the direction of passage of the ear canal 4. In turn, they are polarized in opposite directions so that they attract each other.

The embodiments shown in FIGS. 30a) and 30b) allow the contact elements 2a and 2b to be separated from each other by pulling without generating large force peaks that would displace the first contact element 2a or the first device 1a in the ear canal.

FIG. 31 shows an example of an embodiment of the system with magnetic force rings 5a, 5b. The first contact element 2a has at least one first magnetic force ring 5a as the first magnetic force element and at least one first contact 19a arranged at a center point of the first magnetic force ring 5a. In addition, the second contact element 2b has at least one second magnetic force ring 5b as the second magnetic force element and at least one second contact 19b arranged at a center point of the second magnetic force ring 5b. The contact 19b is designed here as a contact pin 19b, which projects beyond an annular surface of the magnetic force ring 5b, in the center of which it is arranged, in the direction of the contact element 2a. The contact 19a is embedded in a housing of the contact element 2a in such a way that its surface is coplanar with the annular surface of the magnetic force ring 5a. The magnetic force rings 5a and/or 5b can be magnets or can contain or consist of magnetizable material.

In the example shown in FIG. 31, the second contact element 2b is contacted by means of a cable 9b, which is designed here as a conductor strip 9b. The conductor strip 9b is attached to the second contact element 2b eccentrically, i.e. at a radial distance from the center of the magnetic force ring 5b. The conductor strip 9b has two strip conductors that run parallel along the conductor strip 9b. One of the strip conductors makes contact with the contact 19b and the other with the magnetic force ring 5b. In the second contact element 2a, the contact 19a and the magnetic force ring 5a are contacted by conductor 9a. As a result, the contacts 19a, 19b and the conductors 9a and 9b establish a continuous contact via the contact elements 2a and 2b.

In the example shown, the magnetic force rings 5a, 5b are axially polarized and arranged so that there is a north pole and a south pole on the contact side, i.e. the arrangement is either:
52a South Pole, 52b North Pole, 53a South Pole, 53b North Pole or
52a North Pole, 52b South Pole, 53a North Pole, 53b South Pole.

FIG. 32 shows the embodiment shown in FIG. 31 in three perspective views. Reference is made here to the description of FIG. 31.

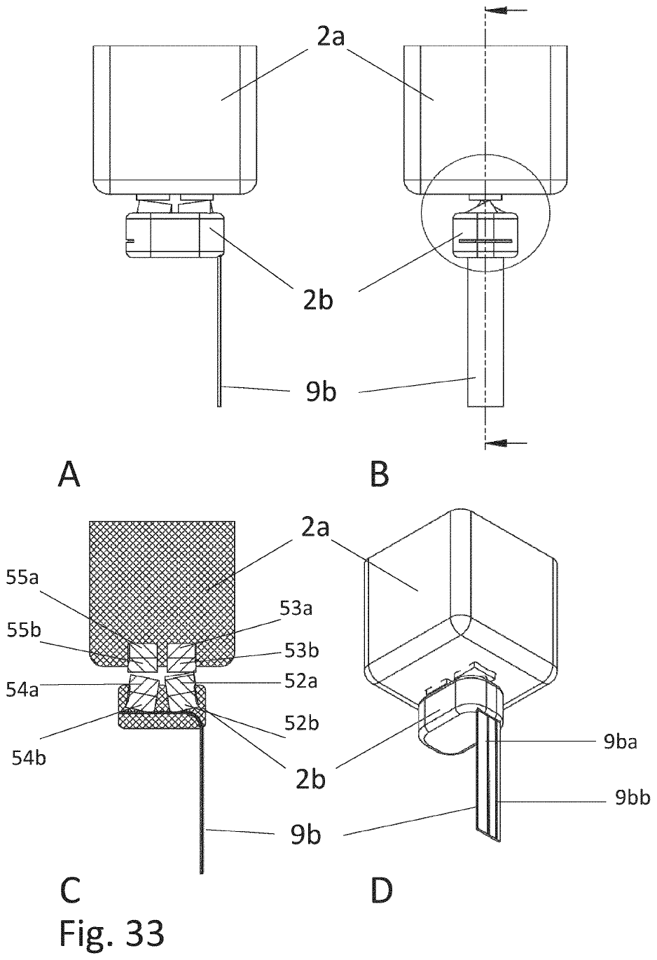

FIG. 33 shows an exemplary embodiment of the contact elements 2a, 2b with cube-shaped magnetic force elements 52, 53, 54 and 55, with the poles marked a and b respectively. The magnetic force elements 52, 53, 54 and 55 are each embedded in a respective housing of the contact elements 2a or 2b, so that their surfaces facing the respective other contact element 2a, 2b protrude beyond the respective housing. The contact element 2b has the magnetic force elements 52 and 54. These are each tilted or tilted about at least one axis (the terms are used synonymously in this document). In this case, the at least one axis is parallel to the surface of the housing in which the magnetic force elements 52 and 54 are embedded.

The first contact element 2a has the magnetic force elements 53 and 55, which are also embedded in the surface of the housing of this contact element 2a that faces the second contact element 2b in the contacted state. These magnetic force elements 53 and 55 are embedded in such a way that their surfaces facing the contact element 2b are parallel to the surface of the housing facing the contact element 2b in which they are arranged.

The magnets of each contact element are polarized (approximately) perpendicular to the contact surface, i.e. the two magnetic force elements of a contact element 2a, 2b are polarized in opposite directions. This means that the contact elements 2a, 2b can only be connected in one polarity. The arrangement is therefore either:
52a South Pole, 52b North Pole, 54a North Pole, 54b South Pole, 53a South Pole, 53b North Pole, 55a North Pole, 55b South Pole or
52a North Pole, 52b South Pole, 54a South Pole, 54b North Pole, 53a North Pole, 53b South Pole, 55a South Pole, 55b North Pole.

This always results in two point contacts via corners of the magnets when connecting (or line contacts via edges with variation below). Dirt is better displaced by point or line contact with a sharp corner or edge than by surface contact

In the example shown in FIG. 33, the second contact element 2b is contacted by a cable 9b, which in this case is a flat cable 9b. This flat cable 9b has two conductors 9ba and 9bb, which run parallel to each other along the cable 9b. In each case, one of the conductors 9ba, 9bb contacts one of the magnetic force elements 52, 54, which are each electrically conductive. For example, the conductor 9ba contacts the magnetic force element 52 and the conductor 9bb contacts the magnetic force element 54 or vice versa.

The flat cable contacts the contact element 2b eccentrically, i.e. at a distance from its center, which can be defined, for example, by the center of the arrangement of the magnetic force elements 52 and 54. When pulled, this causes the side of the contact element 2b to tilt sideways and first one and then the other pair of magnets are released, which reduces the release force and can be less than the contact force (force that presses the contacts together when connected).

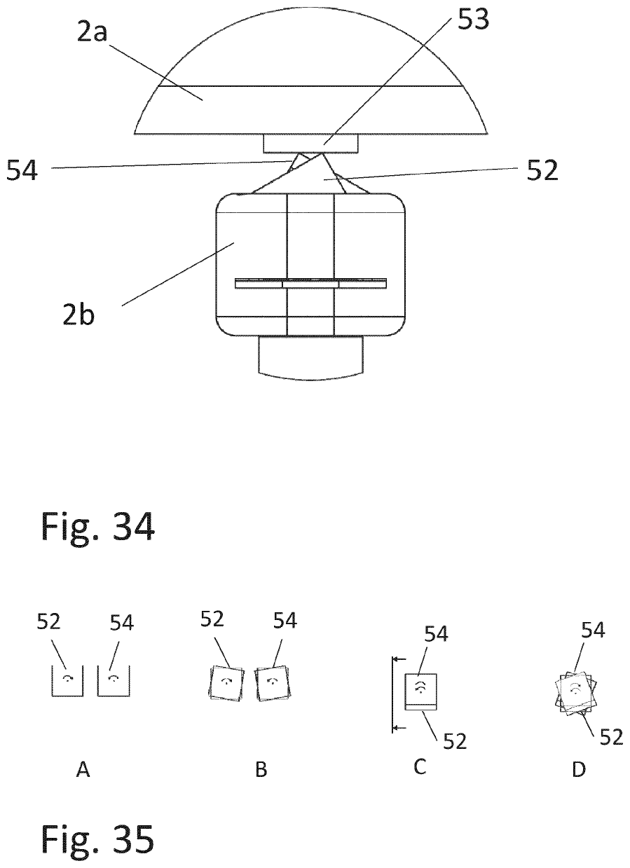

FIG. 34 shows a side view of the arrangement shown in FIG. 33 C as seen from the right-hand side. It can be seen that the magnets 52 and 54 are also tilted about an axis which is perpendicular to the axis about which the magnets 52 and 54 are tilted relative to the surface of the contact element 2b in FIG. 33 C, and which is parallel to this surface.

FIG. 35 shows the tilting of the magnetic force elements 52 and 54 in a step-by-step sequence. In FIG. 35A, the magnetic force elements 52 and 54 are initially not tilted. In FIG. 35B, they are tilted in opposite directions about an axis perpendicular to the plane of the figure. FIG. 35C shows the situation shown in FIG. 53B viewed from the right. The magnetic force elements 52 and 54 are not yet tilted about the axis perpendicular to the plane of FIG. 35C.

1-58. (canceled)

59. A system, comprising
a first device configured to be disposed in an ear canal, wherein the first device comprises a first contact element,
a second device comprising a second contact element, wherein the first and second contact elements are configured to contact each other and to transfer energy and/or data between the first and second devices upon contact with each other, and wherein the first and second devices are further configured to be held in contact with each other by the first contact element and the second contact element by a magnetic force.

60. The system of claim 59,
wherein the first contact element has at least a first magnetic force element,
wherein the second contact element has at least a second magnetic force element,
wherein the at least one first and the at least one second magnetic force elements are configured to exert a magnetic force on each other,
wherein one magnetic force element selected from the at least one first magnetic force element and the at least one second magnetic force element comprises a magnet and the other magnetic force element comprises a magnetizable material, or wherein the at least one first magnetic force element and the at least one second magnetic force element each comprise at least one magnet.

61. The system of claim 59,
wherein the first contact element is connected to a further part of the first device in a mechanically flexible, preferably rotatable and/or tiltable manner.

62. The system of claim 59,
wherein the first and/or the second contact element and/or its magnetic force element have a sheathing that covers the corresponding contact element and/or corresponding magnetic force element completely or completely with the exception of an electrical contact, and which is corrosion-resistant and/or biocompatible and which is preferably non-magnetizable and non-magnetic,
wherein the sheathing preferably comprises or consists of gold, platinum, iridium, an alloy of the aforementioned materials and/or plastic, preferably silicone and/or parylene, and/or ceramic.

63. The system of claim 59,
wherein the first and/or the second contact element has, at least in a region which is in contact with the other contact element on contact, a sheathing, wherein the sheathing is non-magnetizable and non-magnetic,
and wherein a thickness of the sheathing is such that the magnetic force holding the first and second contact element in contact with each other upon contact is less than a force required to remove the first contact element and/or the first device from the ear canal.

64. The system of claim 59, wherein in a state in which the first and second contact element are in contact with each other, the magnetic force is greater than or equal to 1 mN, preferably greater than or equal to 15 mN, preferably greater than or equal to 20mN, preferably greater than or equal to 50 mN, preferably greater than or equal to 100 mN and/or less than or equal to 1000 mN, preferably less than or equal to 800 mN, preferably less than or equal to 600 mN, preferably less than or equal to 500 mN, preferably less than or equal to 400 mN, preferably less than or equal to 300 mN.

65. The system of claim 59
wherein the at least one first and/or the at least one second contact element (2a, 2b) has, on a surface facing the respective other one of the contact elements (2a, 2b) when the first and second contact elements are in contact, at least one spacer element (14a, 14b), which spacer element determines a distance between the at least one first contact element and the at least one second contact element at the location of the spacer element,
wherein preferably the spacer element has a height perpendicular to the surface of the contact element on which it is arranged that is smaller than a diameter of this contact element in the direction parallel to this surface,
wherein preferably the spacer element has a height perpendicular to that surface of the contact element on which it is arranged that is less than or equal to 5 mm, particularly preferably less than or equal to 4 mm, particularly preferably less than 3 mm and/or greater than or equal to 250 μm, preferably greater than or equal to 500 μm.

66. The system according to claim 59,
wherein at least one of the contact elements has a bent course extending in the direction of the other of the contact elements upon contact.

67. The system according to claim 59,
wherein the first and second contact elements each have at least one magnet, and
wherein the magnets of the contact elements are arranged such that they attract each other when the contact elements are in a position relative to each other in which energy and/or data are transmissible between the first and the second device and/or that they repel each other when they are in a position relative to each other in which no intended energy and/or data transmission can be established.

68. The system of claim 59, wherein the first and second contact elements each have at least two magnets whose poles are arranged in such a way that magnets of different contact elements attract one another when the contact elements are in a position relative to one another in which energy and/or data can be transmitted between the first and second devices and/or that they repel one another when they are in a position relative to one another in which no energy and/or data transmission can be established.

69. The system of claim 59, wherein the first and second contact elements represent a galvanic, a capacitive, an inductive, an electromagnetic and/or an optical connection for transmitting the energy and/or the data.

70. The system of claim 59,
wherein the first and the second contact element have mutually compatible contacts, wherein the first and/or the second contact element is a plug contact, spring contact, spring-loaded pin contact, and/or exposed electrode contact.

71. The system of claim 59,
wherein of two surfaces of the first and second contact elements that are able to be brought into contact with one another, one surface has at least one concave region and/or the other surface has at least one convex region,
wherein one or both of the convex or concave regions are spherical segment-shaped, ellipsoidal segment-shaped, conical, pyramidal or crown-shaped.

72. The system of claim 59,
wherein the energy and/or data are optically transmissible,
wherein the first or the second contact element comprises a light source, preferably a light emitting diode or a laser diode, and wherein the other of the contact elements comprises an optical receiving element, preferably a photodiode or a solar cell,
wherein preferably the light source has an emission spectrum in the range of greater than or equal to 350 nm, preferably greater than or equal to 550 nm, particularly preferably greater than or equal to 1400 nm and/or less than or equal to 2000 nm, preferably less than or equal to 1600 nm, and
the optical receiving element has a receiving spectrum into which the emission spectrum of the light source falls.

73. The system of claim 59,
wherein the energy and/or data are optically transmissible,
wherein the second device has at least one optical waveguide with which light can be conducted to the second contact element, wherein the first contact element has an optical receiving element, preferably at least one photodiode or at least one solar cell,
wherein the optical receiving element is preferably set up to convert light energy in the range of greater than or equal to 350 nm, preferably greater than or equal to 550 nm, particularly preferably greater than or equal to 1400 nm and/or less than or equal to 2000 nm, preferably less than or equal to 1600 nm, into voltage.

74. The system of claim 59,
wherein the first contact element is arranged at the end of a cable, the other end of which is connected to a further element of the first device and/or wherein the second contact element is arranged at the end of a cable, the other end of which is connected to a further element of the second device.

75. The system of claim 59,
wherein the first device comprises an eardrum component as a further element of the first device or as part of a further element of the first device, which eardrum component can be arranged on an eardrum in contact therewith and arranged to transmit vibrations directly to the eardrum,
wherein preferably the first contact element is connected to the eardrum component via at least one cable.

76. The system of claim 59,
wherein the second device comprises an ear canal element which can be arranged in the ear canal and which comprises the second contact element, and
wherein the second device also has an outer element which can be arranged further outside than the ear canal element in the ear canal or outside the ear canal, wherein preferably the second contact element is fixedly arranged on the ear canal element.

77. The system of claim 59,
wherein the outer element and the ear canal element are connected via at least one cable and/or at least one optical fiber, via which energy and/or data can be transmitted to and/or from the second contact element, wherein preferably the optical fiber and/or the cable is flexible.

78. The system of claim 59,
wherein the first contact element and the second contact element each have a guide element, wherein the guide element of one of the contact elements is convex and the guide element of the other of the contact elements has a concave shape corresponding to the shape of the guide element of the one contact element,
wherein the guide elements are designed in such a way that they guide the two contact elements into a position in which they are in contact for energy and/or data transmission.
